(19) United States
(12) Patent Application Publication
(10) Pub. No.: US 2023/0273360 A1
(43) Pub. Date: Aug. 31, 2023

(54) PHASE DIFFERENCE PLATE, PHASE DIFFERENCE PLATE WITH TEMPORARY SUPPORT, CIRCULARLY POLARIZING PLATE, AND DISPLAY DEVICE

(71) Applicant: FUJIFILM Corporation, Tokyo (JP)

(72) Inventor: Shuhei OKUDA, Kanagawa (JP)

(73) Assignee: FUJIFILM Corporation, Tokyo (JP)

(21) Appl. No.: 18/169,006

(22) Filed: Feb. 14, 2023

(30) Foreign Application Priority Data
Feb. 25, 2022 (JP) 2022-028413

(51) Int. Cl. G02B 5/30

(52) U.S. Cl. CPC G02B 5/3083; G02B 5/3016

(57) ABSTRACT

Provided are a phase difference plate, a phase difference plate with a temporary support, a circularly polarizing plate, and a display device, in which, when the phase difference plate is combined with a polarizer and then applied as a circularly polarizing plate to a display device and a display device in black display is observed from a front direction and an oblique direction under a fluorescent lamp, tinting of black color is suppressed in any direction. The phase difference plate includes at least three or more optically anisotropic layers, in which the layers are laminated in in direct contact with each other, the phase difference plate includes a first optically anisotropic layer which is formed by fixing a vertically aligned disk-like liquid crystal compound, and a second optically anisotropic layer which is formed by fixing a rod-like liquid crystal compound twist-aligned along a helical axis extending in a thickness direction.

### CROSS-REFERENCE TO RELATED APPLICATIONS

The present application claims priority under 35 U.S.C. § 119 to Japanese Patent Application No. 2022-028413, filed on Feb. 25, 2022. The above application is hereby expressly incorporated by reference, in its entirety, into the present application.

### BACKGROUND OF THE INVENTION

### 1. Field of the Invention

The present invention relates to a phase difference plate, a phase difference plate with a temporary support, a circularly polarizing plate, and a display device.

### 2. Description of the Related Art

An optically anisotropic layer having refractive index anisotropy is applied to various applications such as an antireflection film of a display device and an optical compensation film of a liquid crystal display device.

For example, JP5960743B discloses a phase difference plate in which two types of optically anisotropic layers exhibiting predetermined optical properties are laminated.

### SUMMARY OF THE INVENTION

In recent years, there has been a demand for further improvement of characteristics of the circularly polarizing plate, and particularly, under a fluorescent lamp, which is a stricter condition, there is a demand for suppression of tinting of black color during black display of a display device including the circularly polarizing plate.

The present inventors have found that, in a case where the phase difference plate disclosed in JP5960743B, on which the optically anisotropic layer is laminated, is combined with a polarizer and then applied as a circularly polarizing plate to a display device, the display device is displayed in black, and under a fluorescent lamp, in a case where the display device is observed from a front direction and an oblique direction, there is tinting from black color and there is room for improvement.

The present invention has been made in view of the above-mentioned circumstances, and an object of the present invention is to provide a phase difference plate that, in a case where the phase difference plate is combined with a polarizer and then applied as a circularly polarizing plate to a display device and a display device in black display is observed from a front direction and an oblique direction under a fluorescent lamp, tinting of black color is suppressed in any direction.

Another object of the present invention is to provide a phase difference plate with a temporary support, a circularly polarizing plate, and a display device.

As a result of extensive studies on the problems of the related art, the present inventors have found that the foregoing objects can be achieved by the following configurations.
(1) A phase difference plate comprising:
   at least three or more optically anisotropic layers,
   in which the optically anisotropic layers are laminated in a state of being in direct contact with each other,
   the phase difference plate includes a first optically anisotropic layer which is a layer formed by fixing a vertically aligned disk-like liquid crystal compound, and
   the phase difference plate includes a second optically anisotropic layer which is a layer formed by fixing a rod-like liquid crystal compound twist-aligned along a helical axis extending in a thickness direction.
(2) The phase difference plate according to (1),
   in which an in-plane retardation of the first optically anisotropic layer at a wavelength of 550 nm is 120 to 240 nm.
(3) The phase difference plate according to (1) or (2),
   in which a product And of a refractive index anisotropy Δn of the second optically anisotropic layer at a wavelength of 550 nm and a thickness d of the second optically anisotropic layer is 120 to 240 nm.
(4) The phase difference plate according to any one of (1) to (3),
   in which the phase difference plate includes a third optically anisotropic layer which is a layer formed by fixing a vertically aligned rod-like liquid crystal compound.
(5) The phase difference plate according to (4),
   in which a thickness direction retardation of the third optically anisotropic layer at a wavelength of 550 nm is −120 to −10 nm.
(6) The phase difference plate according to (4) or (5),
   in which the phase difference plate includes the first optically anisotropic layer, the second optically anisotropic layer, and the third optically anisotropic layer in this order.
(7) The phase difference plate according to any one of (1) to (6),
   in which a refractive index of the optically anisotropic layer is more than 1.53.
(8) A phase difference plate with a temporary support, comprising:
   the phase difference plate according to any one of (1) to (7); and a temporary support.
(9) A circularly polarizing plate comprising:
   the phase difference plate according to any one of (1) to (7); and a polarizer.
(10) The circularly polarizing plate according to (9),
   in which a luminosity corrected single transmittance of the polarizer is 42% or more.
(11) A display device comprising:
   the phase difference plate according to any one of (1) to (7); or
   the circularly polarizing plate according to (9) or (10).

According to the present invention, it is possible to provide a phase difference plate that, in a case where the phase difference plate is combined with a polarizer and then applied as a circularly polarizing plate to a display device and a display device in black display is observed from a front direction and an oblique direction under a fluorescent lamp, tinting of black color is suppressed in any direction.

In addition, according to the present invention, it is possible to provide a phase difference plate with a temporary support, a circularly polarizing plate, and a display device.

### BRIEF DESCRIPTION OF THE DRAWINGS

FIG. 1 is an example of a schematic cross-sectional view of an embodiment of a phase difference plate of the present invention.

FIG. 2 is an example of a schematic cross-sectional view of an embodiment of a circularly polarizing plate of the present invention.

FIG. 3 is a view showing a relationship between an absorption axis of a polarizer and an in-plane slow axis of each of a first optically anisotropic layer and a second optically anisotropic layer in the embodiment of the circularly polarizing plate of the present invention.

FIG. 4 is a schematic diagram showing a relationship of an angle between the absorption axis of the polarizer and the in-plane slow axis of each of the first optically anisotropic layer and the second optically anisotropic layer in a case of being observed from a direction of a white arrow in FIG. 2.

### DESCRIPTION OF THE PREFERRED EMBODIMENTS

Hereinafter, the present invention will be described in more detail.

Any numerical range expressed using “to” in the present specification refers to a range including the numerical values before and after the “to” as a lower limit value and an upper limit value, respectively.

In addition, an in-plane slow axis and an in-plane fast axis are defined at a wavelength of 550 nm unless otherwise specified. That is, unless otherwise specified, for example, an in-plane slow axis direction means a direction of the in-plane slow axis at a wavelength of 550 nm.

In the present invention, Re(λ) and Rth(λ) represent an in-plane retardation at a wavelength λ, and a thickness direction retardation at a wavelength λ, respectively. Unless otherwise specified, the wavelength λ, is 550 nm.

In the present invention, Re(λ) and Rth(λ) are values measured at the wavelength of λ, in AxoScan (manufactured by Axometrics, Inc.). By inputting an average refractive index ((nx+ny+nz)/3) and a film thickness (d (μm)) in AxoScan,
slow axis direction)(°
Re(λ)=R0(λ)
Rth(λ)=((nx+ny)/2−nz)×d are calculated.

Although R0(λ) is displayed as a numerical value calculated by AxoScan, it means Re (λ).

In the present specification, the refractive indices nx, ny, and nz are measured using an Abbe refractometer (NAR-4T, manufactured by Atago Co., Ltd.) and using a sodium lamp (λ, =589 nm) as a light source. In addition, in a case of measuring the wavelength dependence, it can be measured with a multi-wavelength Abbe refractometer DR-M2 (manufactured by Atago Co., Ltd.) in combination with a dichroic filter.

In addition, values in Polymer Handbook (John Wiley & Sons, Inc.) and catalogs of various optical films can be used. The values of the average refractive index of main optical films are exemplified below: cellulose acylate (1.48), cycloolefin polymer (1.52), polycarbonate (1.59), polymethylmethacrylate (1.49), and polystyrene (1.59).

In the present specification, “visible light” is intended to refer to light having a wavelength of 400 to 700 nm. In addition, “ultraviolet ray” is intended to refer to light having a wavelength of 10 nm or more and less than 400 nm.

In addition, in the present specification, “orthogonal” or “parallel” is intended to include a range of errors acceptable in the art to which the present invention pertains. For example, it means that an angle is in an error range of ±5° with respect to the exact angle, and the error with respect to the exact angle is preferably in a range of ±3°.

Feature points of the phase difference plate according to the embodiment of the present invention include that a combination of predetermined optically anisotropic layers is used and these optically anisotropic layers are in direct contact with each other. For example, in a case where other layers (for example, an alignment layer and an adhesion layer) are arranged between two optically anisotropic layers, since the optically anisotropic layers and the other layers have different refractive indices, interfacial reflection occurs between the layers, and as a result, it is one of causes of tinting of black color. On the other hand, in the present invention, as described above, since the optically anisotropic layers are in direct contact with each other, it is presumed that the above-described problem is unlikely to occur and a desired effect is obtained.

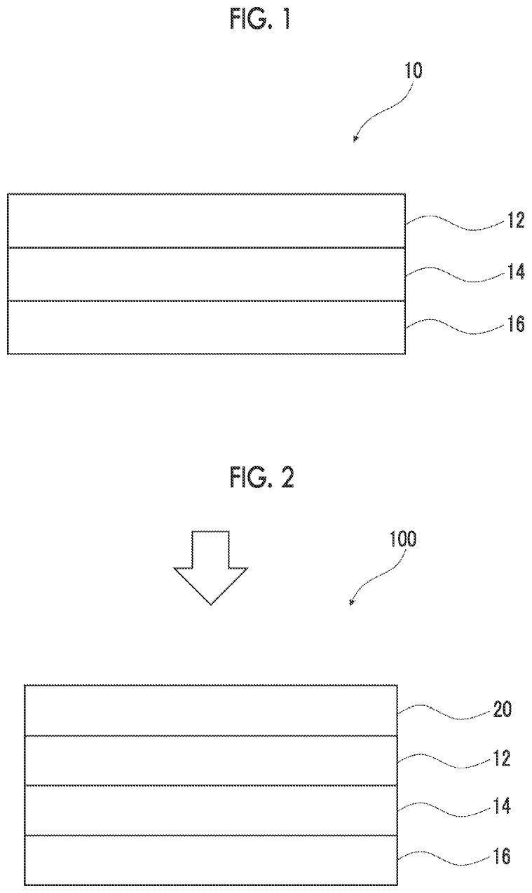

Hereinafter, an embodiment of the phase difference plate according to the present invention will be described with reference to the accompanying drawings. FIG. 1 shows a schematic cross-sectional view of the embodiment of the phase difference plate according to the present invention.

A phase difference plate 10 includes a first optically anisotropic layer 12, a second optically anisotropic layer 14, and a third optically anisotropic layer 16 in this order.

The first optically anisotropic layer 12 is a layer formed by fixing a vertically aligned disk-like liquid crystal compound, the second optically anisotropic layer 14 is a layer formed by fixing a rod-like liquid crystal compound twist-aligned along a helical axis extending in a thickness direction, and the third optically anisotropic layer 16 is a layer formed by fixing a vertically aligned rod-like liquid crystal compound.

As shown in FIG. 1, the first optically anisotropic layer 12 and the second optically anisotropic layer 14 are in direct contact with each other, and the second optically anisotropic layer 14 and the third optically anisotropic layer 16 are in direct contact with each other. That is, no other layer is disposed between the first optically anisotropic layer 12 and the second optically anisotropic layer 14, and no other layer is disposed between the second optically anisotropic layer 14 and the third optically anisotropic layer 16. As described above, in the phase difference plate according to the embodiment of the present invention, the optically anisotropic layers are laminated in a state of being in direct contact with each other.

An angle formed by an in-plane slow axis of the first optically anisotropic layer 12 and an in-plane slow axis of the second optically anisotropic layer 14 on a surface on the first optically anisotropic layer 12 side is preferably 0° to 20°, as will be described later.

Hereinafter, each layer will be described in detail.

First Optically Anisotropic Layer 12

The first optically anisotropic layer 12 is a layer formed by fixing a vertically aligned disk-like liquid crystal compound.

In the present specification, the “fixed” state is a state in which alignment of a liquid crystal compound is maintained. Specifically, the “fixed” state is preferably a state in which, in a temperature range of usually 0° C. to 50° C. or in a temperature range of −30° C. to 70° C. under more severe conditions, the layer has no fluidity and a fixed alignment morphology can be stably maintained without causing a change in the alignment morphology due to an external field or an external force.

The first optically anisotropic layer 12 is a layer formed by fixing a vertically aligned disk-like liquid crystal compound.

The above-described layer formed by fixing a vertically aligned disk-like liquid crystal compound is more specifically a layer formed by fixing a disk-like liquid crystal compound which is vertically aligned and in which optical axes (axes orthogonal to a disc plane) are arranged in the same orientation.

The state in which a disk-like liquid crystal compound is vertically aligned means that the disc plane of the disk-like liquid crystal compound and the thickness direction of the layer are parallel to each other. It is not required to be strictly parallel to each other, and an angle formed by the disc plane and the thickness direction of the layer is preferably 0° to 20° and more preferably 0° to 10°.

In addition, the state in which optical axes (axes orthogonal to the disc plane) of the disk-like liquid crystal compound are arranged in the same orientation does not require that the optical axes of the disk-like liquid crystal compound are arranged strictly in the same orientation, but it is intended that, in a case where orientations of the slow axes are measured at any 20 positions in the plane, the maximum difference in slow axis orientation among the slow axis orientations at 20 positions (the difference between two slow axis orientations having the largest difference among the 20 slow axis orientations) is less than 10°.

An in-plane retardation of the first optically anisotropic layer 12 at a wavelength of 550 nm is not particularly limited, but from the viewpoint that, in a case where the phase difference plate according to the embodiment of the present invention is combined with a polarizer and then applied as a circularly polarizing plate to a display device and a display device in black display is observed from a front direction and an oblique direction under a fluorescent lamp, tinting of black color more is suppressed (hereinafter, simply referred to as that “the effect of the present invention is more excellent”), the in-plane retardation thereof is preferably 120 to 240 nm and more preferably 130 to 230 nm.

A thickness direction retardation of the first optically anisotropic layer 12 at a wavelength of 550 nm is not particularly limited, but from the viewpoint that the effect of the present invention is more excellent, the thickness direction retardation thereof is preferably −120 to −60 nm and more preferably −115 to −65 nm.

A known compound can be used as the disk-like liquid crystal compound.

Examples of the disk-like liquid crystal compound include compounds described in paragraphs [0020] to [0067] of JP2007-108732A and paragraphs [0013] to [0108] of JP2010-244038A.

The disk-like liquid crystal compound may have a polymerizable group.

In the present specification, the type of the polymerizable group is not particularly limited, but is preferably a functional group capable of an addition polymerization reaction, more preferably a polymerizable ethylenically unsaturated group or a ring-polymerizable group, and still more preferably a (meth)acryloyl group, a vinyl group, a styryl group, or an allyl group.

The first optically anisotropic layer 12 is preferably a layer formed by, by polymerization, fixing a disk-like liquid crystal compound which is vertically aligned and has a polymerizable group.

The first optically anisotropic layer 12 may exhibit forward wavelength dispersibility (characteristic that the in-plane retardation decreases as a measurement wavelength increases) or reverse wavelength dispersibility (characteristic that the in-plane retardation increases as the measurement wavelength increases). The above-described forward wavelength dispersibility and reverse wavelength dispersibility are preferably exhibited in a visible light region.

An average thickness of the first optically anisotropic layer 12 is not particularly limited, but is preferably 10 μm or less, more preferably 0.1 to 5.0 μm, and still more preferably 0.3 to 2.0 μm.

The above-described average thickness is obtained by measuring thicknesses of any five or more points of the first optically anisotropic layer 12 and arithmetically averaging the measured values.

Second Optically Anisotropic Layer 14

The second optically anisotropic layer 14 is a layer formed by fixing a rod-like liquid crystal compound twist-aligned along a helical axis extending in a thickness direction.

The second optically anisotropic layer 14 is preferably a layer formed by fixing a so-called chiral nematic phase having a helical structure. In a case of forming the second optically anisotropic layer 14, it is preferable to use at least a rod-like liquid crystal compound and a chiral agent described later.

A twisted angle of the rod-like liquid crystal compound (twisted angle of liquid crystal compound in an alignment direction) is not particularly limited, and is often more than 0° and 360° or less. From the viewpoint that the effect of the present invention is more excellent, the twisted angle thereof is preferably within a range of 80°±30° (within a range of 50° to 110°) and more preferably within a range of 80°±20° (within a range of 60° to 100°).

The twisted angle is measured using an AxoScan (polarimeter) device manufactured by Axometrics, Inc. and using device analysis software of Axometrics, Inc.

In addition, the “rod-like liquid crystal compound twist-aligned” is intended to that the rod-like liquid crystal compound from one main surface to the other main surface of the second optically anisotropic layer 14 is twisted around the thickness direction of the second optically anisotropic layer 14 as an axis. Along with this, the alignment direction (in-plane slow axis direction) of the rod-like liquid crystal compound varies depending on the position of the second optically anisotropic layer 14 in the thickness direction.

In the twisted alignment, a major axis of the rod-like liquid crystal compound is disposed so as to be parallel to the main surface of the second optically anisotropic layer 14. It is not required to be strictly parallel, and an angle formed by the major axis of the rod-like liquid crystal compound and the main surface of the second optically anisotropic layer 14 is preferably 0° to 20° and more preferably 0° to 10°.

A value of a product And of a refractive index anisotropy Δn of the second optically anisotropic layer 14 at a wavelength of 550 nm and a thickness d of the second optically anisotropic layer 14 is not particularly limited, but from the viewpoint that the effect of the present invention is more excellent, it is preferably 120 to 240 nm and more preferably 130 to 230 nm.

The And is measured using an AxoScan (polarimeter) device manufactured by Axometrics, Inc. and using device analysis software of Axometrics, Inc.

An angle formed by the in-plane slow axis of the first optically anisotropic layer 12 and the in-plane slow axis of the second optically anisotropic layer 14 on a surface on the first optically anisotropic layer 12 side is preferably 0° to 20° and more preferably 0° to 10°.

The type of the rod-like liquid crystal compound used for forming the second optically anisotropic layer 14 is not particularly limited, and examples thereof include known compounds.

Examples of the rod-like liquid crystal compound include compounds described in claim 1 of JP1999-513019A (JP-H11-513019A) and paragraphs [0026] to [0098] of JP2005-289980A.

The rod-like liquid crystal compound may have a polymerizable group.

The type of the polymerizable group which may be included in the rod-like liquid crystal compound is as described above.

The second optically anisotropic layer 14 is preferably a layer formed by, by polymerization, fixing a rod-like liquid crystal compound which is twist-aligned and has a polymerizable group.

A ratio of the refractive index anisotropy Δn of the second optically anisotropic layer 14 at a wavelength of 450 nm to the refractive index anisotropy Δn of the second optically anisotropic layer 14 at a wavelength of 550 nm is not particularly limited, but from the viewpoint that the effect of the present invention is more excellent, it is preferably 0.68 to 1.20, more preferably 1.02 to 1.09, and still more preferably 1.04 to 1.07.

A ratio of the refractive index anisotropy Δn of the second optically anisotropic layer 14 at a wavelength of 650 nm to the refractive index anisotropy Δn of the second optically anisotropic layer 14 at a wavelength of 550 nm is not particularly limited, but from the viewpoint that the effect of the present invention is more excellent, it is preferably 0.90 to 1.20 and more preferably 0.92 to 1.00.

An average thickness of the second optically anisotropic layer 14 is not particularly limited, but is preferably 10 μm or less, more preferably 0.1 to 5.0 μm, and still more preferably 0.3 to 2.0 μm.

The above-described average thickness is obtained by measuring thicknesses of any five or more points of the second optically anisotropic layer 14 and arithmetically averaging the measured values.

Third Optically Anisotropic Layer 16

The third optically anisotropic layer 16 is a layer formed by fixing a vertically aligned rod-like liquid crystal compound.

The state in which the rod-like liquid crystal compound is vertically aligned means that a major axis of the rod-like liquid crystal compound and a thickness direction of the third optically anisotropic layer 16 are parallel to each other. It is not required to be strictly parallel to each other, but an angle formed by the major axis of the rod-like liquid crystal compound and the thickness direction of the third optically anisotropic layer 16 is preferably 0° to 20° and more preferably 0° to 10°.

A thickness direction retardation of the third optically anisotropic layer 16 at a wavelength of 550 nm is not particularly limited, but from the viewpoint that the effect of the present invention is more excellent, it is preferably −120 to −10 nm and more preferably −100 to −30 nm.

A known compound can be used as the rod-like liquid crystal compound.

Examples of the rod-like liquid crystal compound include the rod-like liquid crystal compounds exemplified in the second optically anisotropic layer 14.

The rod-like liquid crystal compound may have a polymerizable group.

The type of the polymerizable group which may be included in the rod-like liquid crystal compound is as described above.

The third optically anisotropic layer 16 is preferably a layer formed by, by polymerization, fixing a rod-like liquid crystal compound which is vertically aligned and has a polymerizable group.

An average thickness of the third optically anisotropic layer 16 is not particularly limited, but is preferably 10 μm or less, more preferably 0.1 to 5.0 μm, and still more preferably 0.3 to 2.0 μm.

The above-described average thickness is obtained by measuring thicknesses of any five or more points of the third optically anisotropic layer 16 and arithmetically averaging the measured values.

Other Optically Anisotropic Layers

The phase difference plate 10 may include an optically anisotropic layer other than the above-described first optically anisotropic layer 12 to the third optically anisotropic layer 16. Preferred examples thereof include a fourth optically anisotropic layer shown below, but an optically anisotropic layer different from the fourth optically anisotropic layer may be further included.

Fourth Optically Anisotropic Layer

The phase difference plate 10 may include a fourth optically anisotropic layer on a side of the first optically anisotropic layer 12 opposite to the second optically anisotropic layer 14 side. In a case where the phase difference plate 10 includes the fourth optically anisotropic layer, the first optically anisotropic layer and the fourth optically anisotropic layer are in direct contact with each other.

The fourth optically anisotropic layer is a layer formed by fixing a horizontally aligned disk-like liquid crystal compound.

The state in which the disk-like liquid crystal compound is horizontally aligned means that a disc plane of the disk-like liquid crystal compound and a main surface of the layer are parallel to each other. It is not required to be strictly parallel to each other, but an angle formed by the disc plane and the main surface of the layer is preferably 0° to 20° and more preferably 0° to 10°.

A thickness direction retardation of the fourth optically anisotropic layer at a wavelength of 550 nm is not particularly limited, but from the viewpoint that the effect of the present invention is more excellent, it is preferably 5 to 100 nm and more preferably 10 to 90 nm.

A known compound can be used as the disk-like liquid crystal compound.

Examples of the disk-like liquid crystal compound include the disk-like liquid crystal compounds exemplified in the first optically anisotropic layer 12.

The disk-like liquid crystal compound may have a polymerizable group.

The type of the polymerizable group which may be included in the disk-like liquid crystal compound is as described above.

The fourth optically anisotropic layer is preferably a layer formed by, by polymerization, fixing a disk-like liquid crystal compound which is horizontally aligned and has a polymerizable group.

An average thickness of the fourth optically anisotropic layer is not particularly limited, but is preferably 10 μm or less, more preferably 0.1 to 5.0 μm, and still more preferably 0.3 to 2.0 μm.

The above-described average thickness is obtained by measuring thicknesses of any five or more points of the fourth optically anisotropic layer and arithmetically averaging the measured values.

A refractive index of the optically anisotropic layer (for example, the above-described first optically anisotropic layer to fourth optically anisotropic layer) included in the phase difference plate according to the embodiment of the present invention is not particularly limited, but is preferably more than 1.53 and more preferably 1.55 to 1.65.

In the present specification, a refractive index of an optically anisotropic layer such as an A-plate, a C-plate, and a layer formed by fixing a liquid crystal compound twist-aligned along a helical axis extending in a thickness direction is defined as in Expression (N1). In Expression (N1), nx means a refractive index in a layer in-plane slow axis direction (a direction in which the refractive index in the plane is maximized), and ny means a refractive index in a direction orthogonal to an in-plane slow axis in the plane.

(Refractive index)=(nx+ny)/2 Expression (N1)

In a case where the optically anisotropic layer is the A-plate, the C-plate, or the layer formed by fixing a liquid crystal compound twist-aligned along a helical axis extending in a thickness direction, it is considered that the refractive index is substantially uniform in the film thickness direction.

The above-described refractive index means a refractive index at a wavelength of 550 nm.

The above-described refractive index can be calculated by measuring a reflection spectrum of a layer in which a refractive index is to be measured using a reflection spectroscopic film thickness meter FE 3000, and applying the n-Cauchy dispersion equation to the obtained reflection spectrum.

Method for Producing Phase Difference Plate

A method for producing the phase difference plate is not particularly limited, and any method may be used as long as the optically anisotropic layers are laminated in a state of being in direct contact with each other. For example, in a case of the aspect shown in FIG. 1, a phase difference plate may be produced such that the first optically anisotropic layer and the second optically anisotropic layer are in direct contact with each other and the second optically anisotropic layer and the third optically anisotropic layer are in direct contact with each other.

Hereinafter, as an example, the method for producing an optically anisotropic layer (first optically anisotropic layer to third optically anisotropic layer) using a composition for forming an optically anisotropic layer, containing a liquid crystal compound having a polymerizable group, will be described in detail.

In the following, first, components contained in the composition for forming an optically anisotropic layer will be described in detail.

The liquid crystal compound having a polymerizable group (hereinafter, also referred to as “polymerizable liquid crystal compound”) contained in the composition for forming an optically anisotropic layer is as described above. As described above, a rod-like liquid crystal compound and a disk-like liquid crystal compound are appropriately selected according to the characteristics of an optically anisotropic layer to be formed.

A content of the polymerizable liquid crystal compound in the composition for forming an optically anisotropic layer is preferably 60% to 99% by mass and more preferably 70% to 98% by mass with respect to the total solid content of the composition for forming an optically anisotropic layer.

The solid content means a component capable of forming the optically anisotropic layer, excluding a solvent, and even in a case where a component itself is in a liquid state, such a component is regarded as the solid content.

The composition for forming an optically anisotropic layer may contain a compound other than the liquid crystal compound having a polymerizable group.

For example, a composition for forming an optically anisotropic layer, which is for forming the second optically anisotropic layer 14, preferably contains a chiral agent in order to twist-align the liquid crystal compound. The chiral agent is added to twist-align the liquid crystal compound, but naturally, it is not necessary to add the chiral agent in a case where the liquid crystal compound is a compound exhibiting optical activity such as having an asymmetric carbon in a molecule thereof. In addition, it is not necessary to add the chiral agent, depending on the production method and the twisted angle.

The chiral agent is not particularly limited in a structure thereof as long as it is compatible with the liquid crystal compound used in combination. Any known chiral agent (for example, described in “Liquid Crystal Device Handbook” edited by the 142nd Committee of the Japan Society for the Promotion of Science, Chapter 3, 4-3, Chiral agents for TN and STN, p. 199, 1989) can be used.

An amount of the chiral agent used is not particularly limited, and is adjusted such that the above-described twisted angle is achieved.

The composition for forming an optically anisotropic layer may contain a polymerization initiator. The polymerization initiator used is selected according to the type of polymerization reaction, and examples thereof include a thermal polymerization initiator and a photopolymerization initiator.

A content of the polymerization initiator in the composition for forming an optically anisotropic layer is preferably 0.01% to 20% by mass and more preferably 0.5% to 10% by mass with respect to the total solid content of the composition for forming an optically anisotropic layer.

Examples of other components which may be contained in the composition for forming an optically anisotropic layer include a polyfunctional monomer, an alignment control agent (a vertical alignment agent and a horizontal alignment agent), a surfactant, an adhesion improver, a plasticizer, and a solvent, in addition to the above-described components.

Examples of the other components also include a photo-alignment compound (for example, a photo-alignment polymer).

The photo-alignment compound is a compound having a photo-aligned group, and the photo-aligned group can be aligned in a predetermined direction by irradiation with light.

Next, the method for producing the phase difference plate including the first optically anisotropic layer to third optically anisotropic layer, specifically shown in FIG. 1, will be described in detail.

In producing the phase difference plate, first, a composition for forming an optically anisotropic layer, containing a polymerizable rod-like liquid crystal compound, is applied onto a substrate, the formed coating film is subjected to an alignment treatment to align the polymerizable rod-like liquid crystal compound in the coating film, and a curing treatment is performed to form the third optically anisotropic layer.

The substrate may be a temporary support. That is, in a case where the base material is a temporary support, a phase difference plate with a temporary support, including the temporary support and the phase difference plate, is finally obtained. Since the temporary support can be peeled off, the above-described phase difference plate with a temporary support can be used as a so-called transfer film.

Examples of a method of applying the composition for forming an optically anisotropic layer include a curtain coating method, a dip coating method, a spin coating method, a printing coating method, a spray coating method, a slot coating method, a roll coating method, a slide coating method, a blade coating method, a gravure coating method, and a wire bar method.

The alignment treatment can be performed by drying the coating film at room temperature or by heating the coating film. In a case of forming the third optically anisotropic layer, the polymerizable rod-like liquid crystal compound is vertically aligned.

Conditions in a case of heating the coating film are not particularly limited, and the heating temperature is preferably 50° C. to 250° C. and more preferably 50° C. to 150° C., and the heating time is preferably 10 seconds to 10 minutes.

In addition, after the coating film is heated, the coating film may be cooled as necessary, before a curing treatment (light irradiation treatment) described later.

A method of the curing treatment performed on the coating film in which the polymerizable rod-like liquid crystal compound is vertically aligned is not particularly limited, and examples thereof include a light irradiation treatment and a heat treatment. Among these, from the viewpoint of production suitability, a light irradiation treatment is preferable, and an ultraviolet irradiation treatment is more preferable.

Irradiation conditions of the light irradiation treatment are not particularly limited, and an irradiation amount of 50 to 1,000 mJ/cm² is preferable.

The atmosphere during the light irradiation treatment is not particularly limited, but is preferably a nitrogen atmosphere.

Next, a composition for forming an optically anisotropic layer, containing a polymerizable rod-like liquid crystal compound and a chiral agent, is applied onto the formed third optically anisotropic layer, the formed coating film is subjected to an alignment treatment to align the polymerizable liquid crystal compound in the coating film, and a curing treatment is performed to form the second optically anisotropic layer.

The procedure for forming the second optically anisotropic layer is the same as the procedure for forming the third optically anisotropic layer.

By the above-described treatments, a laminate which includes the second optically anisotropic layer and the third optically anisotropic layer and in which both are in direct contact with each other is obtained.

Before applying the composition for forming an optically anisotropic layer, which is for forming the second optically anisotropic layer, onto the third optically anisotropic layer, a surface of the third optically anisotropic layer may be subjected to a rubbing treatment as necessary. In addition, in a case where the photo-alignment polymer is unevenly distributed on the surface of the third optically anisotropic layer, the photo-alignment polymer on the surface of the third optically anisotropic layer may be aligned by irradiation with light to impart alignment restriction force.

Next, a composition for forming an optically anisotropic layer, containing a polymerizable disk-like liquid crystal compound, is applied onto the formed second optically anisotropic layer, the formed coating film is subjected to an alignment treatment to align the polymerizable disk-like liquid crystal compound in the coating film, and a curing treatment is performed to form the first optically anisotropic layer.

The procedure for forming the first optically anisotropic layer is the same as the procedure for forming the third optically anisotropic layer.

By the above-described treatments, the phase difference plate which includes the first optically anisotropic layer, the second optically anisotropic layer, and the third optically anisotropic layer and in which the first optically anisotropic layer and the second optically anisotropic layer are in direct contact with each other and the second optically anisotropic layer and the third optically anisotropic layer are in direct contact with each other is obtained.

Before applying the composition for forming an optically anisotropic layer, which is for forming the first optically anisotropic layer, onto the second optically anisotropic layer, a surface of the second optically anisotropic layer may be subjected to a corona treatment as necessary. By performing the corona treatment, the surface of the second optically anisotropic layer is more hydrophilic, and vertical alignment property of the polymerizable disk-like liquid crystal compound is further promoted.

In addition, in a case where the photo-alignment polymer is unevenly distributed on the surface of the second optically anisotropic layer, the photo-alignment polymer on the surface of the second optically anisotropic layer may be aligned by irradiation with light to impart alignment restriction force. In addition, in a case where the photo-alignment polymer is cleaved by the irradiation with light to generate a hydrophilic group, the surface of the second optically anisotropic layer is more hydrophilic, and the vertical alignment property of the polymerizable disk-like liquid crystal compound is further promoted.

The total thickness of the optically anisotropic layers included in the phase difference plate is not particularly limited, but from the viewpoint of thinning, it is preferably 10 μm or less and more preferably 7 μm or less. The lower limit thereof is not particularly limited, but is preferably 0.1 μm or more.

In FIG. 1, the aspect in which the first optically anisotropic layer 12, the second optically anisotropic layer 14, and the third optically anisotropic layer 16 are arranged in this order has been described, the present invention may have other aspects.

For example, the lamination order of the first optically anisotropic layer 12, the second optically anisotropic layer 14, and the third optically anisotropic layer 16 may be different from that in FIG. 1.

Circularly Polarizing Plate

The phase difference plate according to the embodiment of the present invention can be used as a circularly polarizing plate in combination with a polarizer. The circularly polarizing plate is an optical element which converts unpolarized light into circularly polarized light.

The circularly polarizing plate according to the embodiment of the present invention, having the above-described configuration, is suitably used for antireflection applications of a display device such as a liquid crystal display device (LCD), a plasma display panel (PDP), an electroluminescent display (ELD), or a cathode tube display device (CRT).

The polarizer may be a member having a function of converting natural light into specific linearly polarized light, and examples thereof include an absorption type polarizer.

The type of the polarizer is not particularly limited, and a commonly used polarizer can be used. Examples thereof include an iodine-based polarizer, a dye-based polarizer using a dichroic substance, and a polyene-based polarizer. The iodine-based polarizer and the dye-based polarizer are generally produced by adsorbing iodine or a dichroic dye on a polyvinyl alcohol, followed by stretching.

A protective film may be disposed on one side or both sides of the polarizer.

The polarizer is preferably a polarizer formed of a composition containing a dichroic substance and a liquid crystal compound having a polymerizable group.

The dichroic substance is not particularly limited, and conventionally known dichroic substances (dichroic coloring agents) including a visible light absorbing substance (a dichroic coloring agent), a luminescent substance (a fluorescent substance, a phosphorescent substance), an ultraviolet absorbing substance, an infrared absorbing substance, a nonlinear optical substance, a carbon nanotube, and an inorganic substance (for example, a quantum rod) can be used.

In the present invention, two or more dichroic substances may be used in combination. For example, from the viewpoint of bringing a light absorption anisotropic film closer to black, it is preferable to use at least one coloring agent compound having a maximal absorption wavelength in a wavelength range of 370 to 550 nm and at least one coloring agent compound having a maximal absorption wavelength in a wavelength range of 500 to 700 nm in combination.

A luminosity corrected single transmittance of the polarizer is not particularly limited, but from the viewpoint that the effect of the present invention is more excellent, it is preferably 42% or more and more preferably 43% or more. The upper limit thereof is not particularly limited, but is preferably 48% or less.

The luminosity corrected single transmittance is calculated by the following method.

For the polarizer, a transmittance (T1) in an absorption axis direction in a wavelength range of 380 to 780 nm and a transmittance (T2) in a direction orthogonal to the absorption axis are measured using a spectrophotometer with an integrating sphere [“V7100” manufactured by JASCO Corporation], and a single transmittance at each wavelength is calculated based on the following expression.

Single transmittance (%)=(T1+T2)/2

Regarding the obtained single transmittance, luminosity correction is carried out by a two-degree field of view (C light source) of JIS Z 8701: 1999 “Color display method—XYZ color system and X10Y10Z10 color system”, whereby the luminosity corrected single transmittance is obtained.

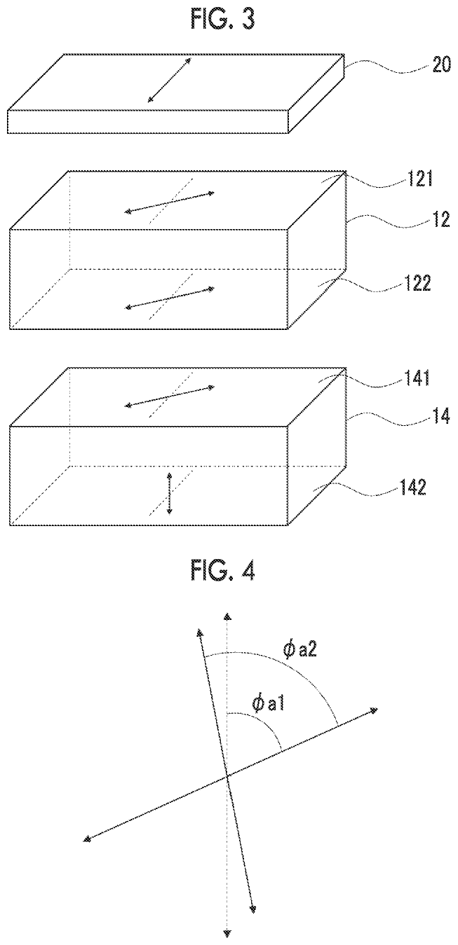

FIG. 2 shows a schematic cross-sectional view of an embodiment of the circularly polarizing plate 100. In addition, FIG. 3 is a view showing a relationship between an absorption axis of a polarizer 20 and in-plane slow axes of each of the first optically anisotropic layer 12 and the second optically anisotropic layer 14 in the circularly polarizing plate 100 shown in FIG. 2. In FIG. 3, an arrow in the polarizer 20 indicates an absorption axis, and arrows in the first optically anisotropic layer 12 and the second optically anisotropic layer 14 indicate in-plane slow axes in each layer.

In addition, FIG. 4 is a view showing a relationship of the angle between the absorption axis (broken line) of the polarizer 20 and the in-plane slow axes (solid lines) of each of the first optically anisotropic layer 12 and the second optically anisotropic layer 14, upon observation from the white arrow in FIG. 2.

A rotation angle of the in-plane slow axes is represented by a positive angle value in a counterclockwise direction and a negative angle value in a clockwise direction, with respect to the absorption axis of the polarizer 20 (0°), upon observation from the white arrow in FIG. 2. In addition, whether the twisted direction of the liquid crystal compound is a right-handed twist (clockwise) or a left-handed twist (counterclockwise) is determined with reference to the in-plane slow axis on the surface of the front side (the polarizer 20 side) in the second optically anisotropic layer 14, upon observation from the white arrow in FIG. 2.

As shown in FIG. 2, the circularly polarizing plate 100 includes the polarizer 20, the first optically anisotropic layer 12, the second optically anisotropic layer 14, and the third optically anisotropic layer 16 in this order.

As shown in FIG. 3 and FIG. 4, an angle (pal formed by the absorption axis of the polarizer 20 and the in-plane slow axis of the first optically anisotropic layer 12 is 76°. More specifically, the in-plane slow axis of the first optically anisotropic layer 12 is rotated by −76° (76° clockwise) with respect to the absorption axis of the polarizer 20. FIG. 3 and FIG. 4 show an aspect in which the in-plane slow axis of the first optically anisotropic layer 12 is at a position of −76°, but the present invention is not limited to this aspect. The in-plane slow axis of the first optically anisotropic layer 12 is preferably in a range of −40° to −85°, more preferably in a range of −50° to −85°, and still more preferably in a range of −65° to −85°. That is, the angle formed by the absorption axis of the polarizer 20 and the in-plane slow axis of the first optically anisotropic layer 12 is preferably in a range of 40° to 85°, more preferably in a range of 50° to 85°, and still more preferably in a range of 65° to 85°.

As shown in FIG. 3, in the first optically anisotropic layer 12, the in-plane slow axis of the first optically anisotropic layer 12 on a surface 121 on the polarizer 20 side is parallel to the in-plane slow axis of the first optically anisotropic layer 12 on a surface 122 on the second optically anisotropic layer 14 side.

As shown in FIG. 3 and FIG. 4, the in-plane slow axis of the first optically anisotropic layer 12 is parallel to the in-plane slow axis of the second optically anisotropic layer 14 on a surface 141 on the first optically anisotropic layer 12 side.

The present invention is not limited to this aspect, and the angle formed by the in-plane slow axis of the first optically anisotropic layer 12 and the in-plane slow axis of the second optically anisotropic layer 14 on the surface 141 on the first optically anisotropic layer 12 side is preferably in a range of 0° to 20°.

As described above, the second optically anisotropic layer 14 is a layer formed by fixing a rod-like liquid crystal compound twist-aligned along the helical axis extending in the thickness direction. Therefore, as shown in FIG. 3 and FIG. 4, the in-plane slow axis of the second optically anisotropic layer 14 on the surface 141 on the first optically anisotropic layer 12 side and the in-plane slow axis of the second optically anisotropic layer 14 on a surface 142 opposite to the first optically anisotropic layer 12 side form the above-described twisted angle (81° in FIG. 3). That is, an angle φ2 formed by the in-plane slow axis of the second optically anisotropic layer 14 on the surface 141 on the first optically anisotropic layer 12 side and the in-plane slow axis of the second optically anisotropic layer 14 on the surface 142 opposite to the first optically anisotropic layer 12 side is 81°. More specifically, the twisted direction of the rod-like liquid crystal compound in the second optically anisotropic layer 14 is a left-handed twist (counterclockwise), and the twisted angle thereof is 81°.

Although FIG. 3 and FIG. 4 show an aspect in which the twisted angle of the rod-like liquid crystal compound in the second optically anisotropic layer 14 is 81°, the present invention is not limited to this aspect. As described above, the twisted angle of the rod-like liquid crystal compound is preferably within a range of 80°±30°. That is, the angle formed by the in-plane slow axis of the second optically anisotropic layer 14 on the surface 141 on the first optically anisotropic layer 12 side and the in-plane slow axis of the second optically anisotropic layer 14 on the surface 142 opposite to the first optically anisotropic layer 12 side is preferably within a range of 80°±30°.

As described above, in the aspect of FIG. 3 and FIG. 4, the in-plane slow axis of the first optically anisotropic layer 12 is rotated clockwise by 76°, and the twisted direction of the rod-like liquid crystal compound in the second optically anisotropic layer 14 is counterclockwise (left-handed twist), with reference to the absorption axis of the polarizer 20, upon observation of the circularly polarizing plate 100 from the polarizer 20 side.

In FIG. 3 and FIG. 4, the aspect in which the twisted direction of the rod-like liquid crystal compound is counterclockwise has been described in detail, but an aspect in which the twisted direction of the rod-like liquid crystal compound is clockwise may be configured as long as the relationship of the predetermined angle is satisfied. More specifically, it may be an aspect in which the in-plane slow axis of the first optically anisotropic layer 12 is rotated counterclockwise by 76°, and the twisted direction of the rod-like liquid crystal compound in the second optically anisotropic layer 14 is clockwise (right-handed twist), with reference to the absorption axis of the polarizer 20, upon observation of the circularly polarizing plate 100 from the polarizer 20 side.

That is, in the circularly polarizing plate including the phase difference plate shown in FIG. 2, in a case where the in-plane slow axis of the first optically anisotropic layer is rotated clockwise within a range of 40° to 85° (preferably 50° to 85° and more preferably 65° to 85°) with reference to the absorption axis of the polarizer, upon observation of the circularly polarizing plate from the polarizer side, it is preferable that the twisted direction of the rod-like liquid crystal compound in the second optically anisotropic layer is counterclockwise with reference to the in-plane slow axis of the second optically anisotropic layer on the surface on the first optically anisotropic layer side.

In addition, in the circularly polarizing plate including the phase difference plate shown in FIG. 2, in a case where the in-plane slow axis of the first optically anisotropic layer is rotated counterclockwise within a range of 40° to 85° (preferably 50° to 85° and more preferably 65° to 85°) with reference to the absorption axis of the polarizer, upon observation of the circularly polarizing plate from the polarizer side, it is preferable that the twisted direction of the rod-like liquid crystal compound in the second optically anisotropic layer is clockwise with reference to the in-plane slow axis of the second optically anisotropic layer on the surface on the first optically anisotropic layer side. Even in a case where the twisted direction of the rod-like liquid crystal compound in the second optically anisotropic layer is clockwise, it is preferable that the angle formed by the in-plane slow axis of the first optically anisotropic layer and the in-plane slow axis of the second optically anisotropic layer on the surface on the first optically anisotropic layer side is within a range of 0° to 20°.

The above-described circularly polarizing plate may include a member other than the phase difference plate and the polarizer.

The circularly polarizing plate may include an adhesion layer between the phase difference plate and the polarizer.

Examples of the adhesion layer include known pressure sensitive adhesive layers and adhesive layers.

In addition, the circularly polarizing plate may include an alignment film between the phase difference plate and the polarizer, but from the viewpoint of suppressing tinting of black color, it is preferable not to include the alignment film between the phase difference plate and the polarizer.

A method for producing the above-described circularly polarizing plate is not particularly limited, and a known method can be mentioned.

For example, a method of bonding a polarizer and a phase difference plate through an adhesion layer can be mentioned.

Uses

The above-described phase difference plate can be applied to various uses, and can also be used, for example, as a so-called λ/4 plate or λ/2 plate by adjusting optical properties of each optically anisotropic layer.

The λ/4 plate is a plate having a function of converting linearly polarized light having a specific wavelength into circularly polarized light (or circularly polarized light into linearly polarized light). More specifically, the λ/4 plate is a plate in which the in-plane retardation Re at a predetermined wavelength λ nm is λ/4 (or an odd multiple thereof).

An in-plane retardation (Re(550)) of the λ/4 plate at a wavelength of 550 nm may have an error of approximately 25 nm based on an ideal value (137.5 nm), and is, for example, preferably 110 to 160 nm and more preferably 120 to 150 nm.

In addition, the λ/2 plate refers to an optically anisotropic film in which an in-plane retardation Re(λ) at a specific wavelength of λ nm satisfies Re(λ)≈λ/2. This expression may be achieved at any wavelength (for example, 550 nm) in the visible light region. Among these, it is preferable that the in-plane retardation Re(550) at a wavelength of 550 nm satisfies the following relationship.

210 nm≤Re(550)≤300 nm

Display Device

The phase difference plate and circularly polarizing plate according to the embodiment of the present invention can be suitably applied to a display device.

The display device according to the embodiment of the present invention includes a display element and the above-described phase difference plate or circularly polarizing plate.

In a case where the phase difference plate according to the embodiment of the present invention is applied to the display device, it is preferable to be applied as the above-described circularly polarizing plate. In this case, the circularly polarizing plate is disposed on a viewing side, and the polarizer is disposed on the viewing side in the circularly polarizing plate.

The display element is not particularly limited, and examples thereof include an organic electroluminescence display element and a liquid crystal display element.

### EXAMPLES

Hereinafter, features of the present invention will be described in more detail with reference to Examples and Comparative Examples. The materials, amounts used, proportions, treatment details, and treatment procedure shown in the following Examples can be appropriately changed without departing from the spirit and scope of the present invention. Accordingly, the scope of the present invention should not be construed as being limited by the specific examples given below.

### Example 1

Production of Linearly Polarizing Plate

A surface of a support of a cellulose triacetate film TJ25 (manufactured by Fujifilm Corporation; thickness: 25 μm) was subjected to an alkali saponification treatment. Specifically, the support was immersed in a 1.5 N sodium hydroxide aqueous solution at 55° C. for 2 minutes, washed in a water bath at room temperature, and further neutralized with a 0.1 N sulfuric acid at 30° C. After neutralization, the support was washed in a water bath at room temperature and further dried with hot air at 100° C. to obtain a polarizer protective film.

A roll-like polyvinyl alcohol (PVA) film having a thickness of 60 μm was continuously stretched in an iodine aqueous solution in a longitudinal direction, and dried to obtain a polarizer having a thickness of 13 μm. The luminosity corrected single transmittance of the polarizer was 43%. In this case, an absorption axis direction of the polarizer coincided with the longitudinal direction.

The above-described polarizer protective film was bonded to one surface of the above-described polarizer using the following PVA adhesive to produce a linearly polarizing plate.

Preparation of PVA adhesive 100 parts by mass of a polyvinyl alcohol-based resin having an acetoacetyl group (average degree of polymerization: 1200, degree of saponification: 98.5 mol %, degree of acetoacetylation: 5 mol %) and 20 parts by mass of methylol melamine were dissolved in pure water under a temperature condition of 30° C. to prepare a PVA adhesive as an aqueous solution adjusted to a concentration of solid contents of 3.7% by mass.

Production of Cellulose Acylate Film

The following composition was put into a mixing tank, stirred, and further heated at 90° C. for 10 minutes. Thereafter, the obtained composition was filtered through a filter paper having an average pore diameter of 34 μm and a sintered metal filter having an average pore diameter of 10 μm to prepare a dope. The concentration of solid contents of the dope was 23.5% by mass, and the solvent of the dope was methylene chloride/methanol/butanol=81/18/1 (mass ratio).

Cellulose acylate dope

| | |
|---|---|
| Cellulose acylate (acetyl substitution degree: 2.86, | 100 parts by mass |
| viscosity average degree of polymerization: 310) | |
| Sugar ester compound 1 (represented by Formula | 6.0 parts by mass |
| (S4)) | |
| Sugar ester compound 2 (represented by Formula | 2.0 parts by mass |
| (S5)) | |
| Silica particle dispersion (AEROSIL R972, | 0.1 parts by mass |
| manufactured by Nippon Aerosil Co., Ltd.) | |
| Solvent (methylene chloride/methanol/butanol) | |

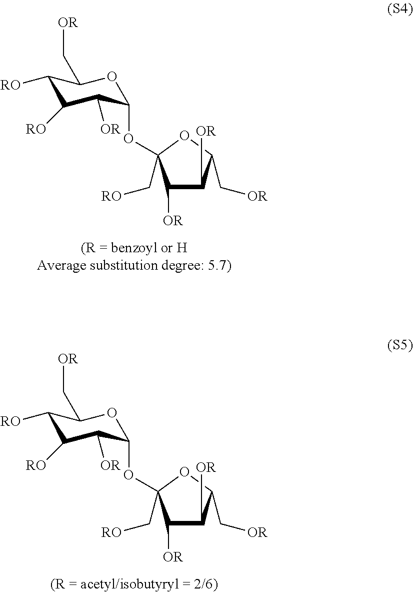

The dope produced above was cast using a drum film forming machine. The dope was cast from a die such that it was in contact with a metal support cooled to 0° C., and then the obtained web (film) was stripped. The drum was made of SUS.

The web (film) obtained by casting was peeled off from the drum, and then dried in a tenter device for 20 minutes at 30° C. to 40° C. during film transport, using the tenter device that clipped and transported both ends of the web. Subsequently, the web was post-dried by zone heating while being rolled. The obtained web was knurled and then wound up.

In the obtained cellulose acylate film, a film thickness was 40 μm, an in-plane retardation at a wavelength of 550 nm was 1 nm, and a thickness direction retardation at a wavelength of 550 nm was 26 nm.

Formation of Optically Anisotropic Layer (1a)

A composition (1a) for forming an optically anisotropic layer, containing a rod-like liquid crystal compound and having the following composition, was applied onto the cellulose acylate film produced above using a Geeser coating machine to form a coating film. Thereafter, both ends of the film were held, a cooling plate (9° C.) was installed on the side of the surface on which the coating film of the film was formed so that the distance from the film was 5 mm, and a heater (75° C.) was installed on the side opposite to the surface on which the coating film of the film was formed so that the distance from the film was 5 mm, followed by drying for 2 minutes.

Next, the obtained coating film was heated with hot air at 60° C. for 1 minute, and irradiated with ultraviolet rays having an irradiation amount of 100 mJ/cm² using a 365 nm UV-LED while purging with nitrogen so as to have an atmosphere having an oxygen concentration of 100 ppm or less. Thereafter, the obtained film was annealed with hot air at 120° C. for 1 minute to form an optically anisotropic layer (1a).

The obtained optically anisotropic layer (1a) was irradiated with UV light (ultra-high pressure mercury lamp; UL750, manufactured by HOYA Corporation) passing through a wire grid polarizer at room temperature at 7.9 mJ/cm² (wavelength: 313 nm) to impart alignment control ability to the surface.

A film thickness of the formed optically anisotropic layer (1a) was 0.5 μm. An in-plane retardation of the optically anisotropic layer (1a) at a wavelength of 550 nm was 0 nm, and a thickness direction retardation of the optically anisotropic layer (1a) at a wavelength of 550 nm was −68 nm. It was confirmed that an average tilt angle of a major axis direction of the rod-like liquid crystal compound with respect to the film surface was 90° and the rod-like liquid crystal compound was aligned perpendicular to the film surface.

Composition (1a) for forming optically anisotropic layer

| | | |
|---|---|---|
| Rod-like liquid crystal compound (A) shown | 100 | parts by mass |
| below | | |
| Polymerizable monomer (A-400, manufactured by | 4.0 | parts by mass |
| Shin-Nakamura Chemical Co., Ltd.) | | |
| Polymerization initiator S-1 (oxime type) shown | 5.0 | parts by mass |
| below | | |
| Photoacid generator D-1 shown below | 3.0 | parts by mass |
| Polymer M-1 shown below | 2.0 | parts by mass |
| Vertical alignment agent S01 shown below | 2.0 | parts by mass |
| Photo-alignment polymer A-1 shown below | 0.8 | parts by mass |
| Methyl ethyl ketone | 42.3 | parts by mass |
| Methyl isobutyl ketone | 627.5 | parts by mass |

Rod-Like Liquid Crystal Compound (A) (Mixture of Compounds Shown Below)

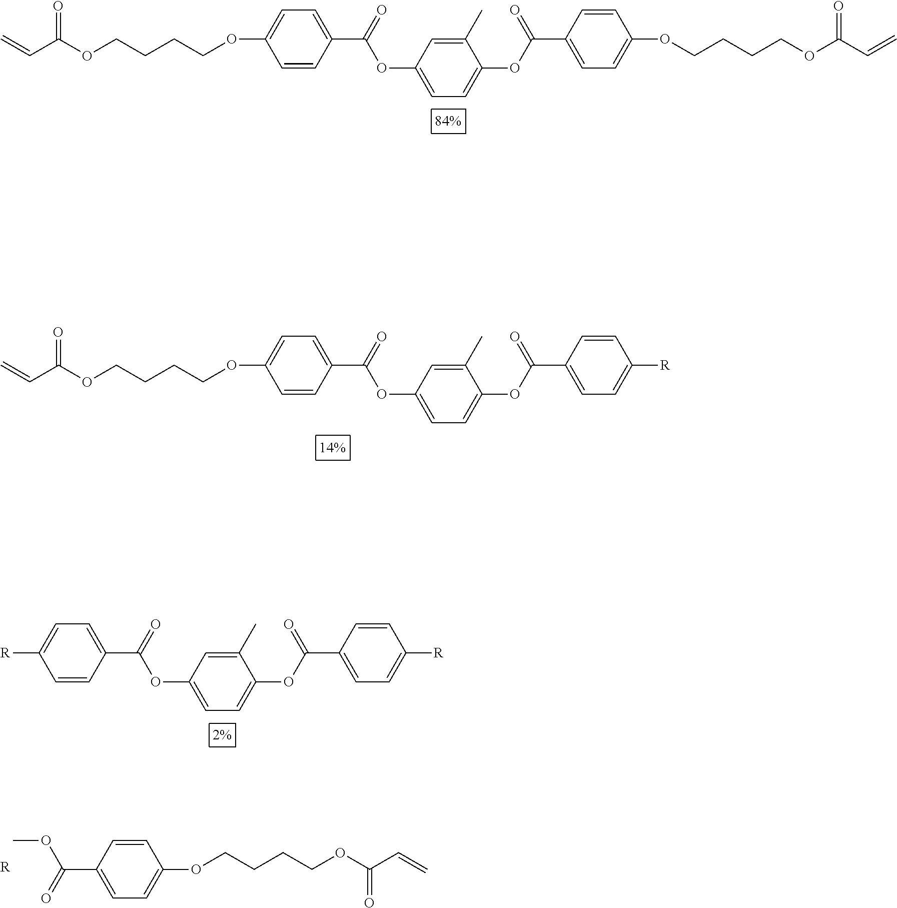

Polymerization Initiator S-1

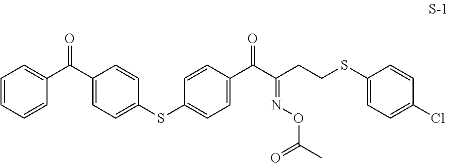 [SMILES: CC(=O)O/N=C(\CCSc1ccc(Cl)cc1)C(=O)c1ccc(Sc2ccc(C(=O)c3ccccc3)cc2)cc1]

Photoacid Generator D-1

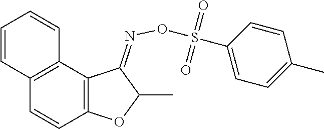 [SMILES: Cc1ccc(S(=O)(=O)O/N=C2/c3c(ccc4ccccc34)OC2C)cc1]

Polymer M-1 (numerical value in each repeating unit represents a content (% by mass) with respect to all repeating units; in addition, a weight-average molecular weight was 60,000)

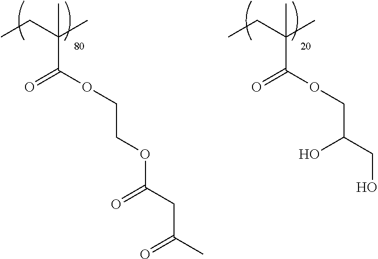

Vertical Alignment Agent S01

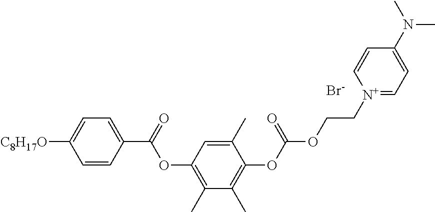

Photo-alignment polymer A-1 (numerical value described in each repeating unit represents a content (% by mass) of each repeating unit with respect to all repeating units, which was 40% by mass, 25% by mass, and 35% by mass from the left repeating unit; in addition, a weight-average molecular weight was 69,300)

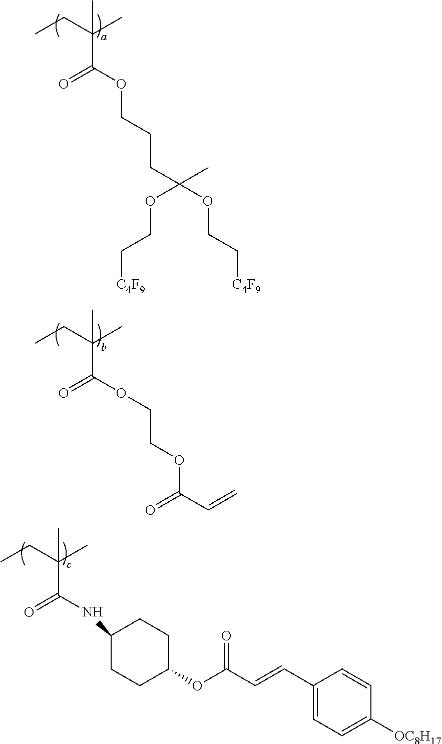

Formation of Optically Anisotropic Layer (1b)

Next, a composition (1b) for forming an optically anisotropic layer, containing a rod-like liquid crystal compound and having the following composition, was applied onto the optically anisotropic layer (1a) produced above using a Geeser coating machine, and heated with hot air at 80° C. for 60 seconds. Next, the coating film was irradiated with ultraviolet rays having an irradiation amount of 100 mJ/cm² at 80° C. using a 365 nm UV-LED while purging with nitrogen so as to have an atmosphere having an oxygen concentration of 100 ppm or less. Thereafter, the obtained film was annealed with hot air at 120° C. for 1 minute to form an optically anisotropic layer (1b).

The obtained optically anisotropic layer (1b) was irradiated with UV light (ultra-high pressure mercury lamp; UL750, manufactured by HOYA Corporation) passing through a wire grid polarizer at room temperature at 7.9 mJ/cm² (wavelength: 313 nm) to impart alignment control ability to the surface.

In the optically anisotropic layer (1b), a thickness was 1.2 And at a wavelength of 550 nm was 164 nm, and a twisted angle of the liquid crystal compound was 81°. In a case of viewing from the optically anisotropic layer (1b) side, assuming that a width direction of the film is defined as 0° (a longitudinal direction is defined as 90°), an in-plane slow axis direction of the optically anisotropic layer (1b) on a surface on the air side was 14°, and an in-plane slow axis direction of the optically anisotropic layer (1b) on a surface in contact with an optically anisotropic layer (1c) was 95°.

The above-described in-plane slow axis direction is expressed as negative in a case where it is clockwise (right-handed turning) and positive in a case where it is counterclockwise (left-handed turning) with the width direction of the substrate as a reference of 0°, upon observing the substrate from the surface side of the optically anisotropic layer.

In addition, the twisted angle of the liquid crystal compound is expressed as negative in a case where the in-plane slow axis direction on the substrate side (back side) is clockwise (right-handed turning) and positive in a case where it is counterclockwise (left-handed turning) with reference to the in-plane slow axis direction on the surface side (front side), upon observing the substrate from the surface side of the optically anisotropic layer.

In this way, a laminate (1a-1b) in which the optically anisotropic layer (1a) and the optically anisotropic layer (1b) were directly laminated on a long cellulose acylate film was produced.

Composition (1b) for forming optically anisotropic layer

| | | |
|---|---|---|
| Rod-like liquid crystal compound (A) shown | 100 | parts by mass |
| above | | |
| Ethylene oxide-modified trimethylolpropane | 4 | parts by mass |
| triacrylate (V # 360, manufactured by Osaka | | |
| Organic Chemical Industry Ltd.) | | |
| Photoacid generator D-1 shown above | 3.0 | parts by mass |
| Photopolymerization initiator (Irgacure 819, | 3 | parts by mass |
| manufactured by BASF SE) | | |
| Left-handed twisting chiral agent (L1) shown | 0.60 | parts by mass |
| below | | |
| Photo-alignment polymer A-1 shown above | 2.00 | parts by mass |
| Methyl ethyl ketone | 156 | parts by mass |

Left-Handed Twisting Chiral Agent (L1)

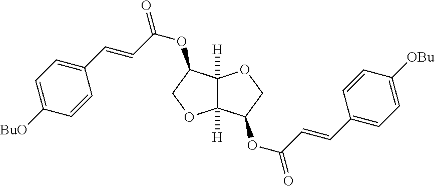

A composition (1c) for forming an optically anisotropic layer, containing a disk-like liquid crystal compound and having the following composition, was applied onto the laminate (1a-1b) produced as described above, in which the optically anisotropic layer (1a) and the optically anisotropic layer (1b) are directly laminated on the long cellulose acylate film, using a Geeser coating machine to form a coating film. Next, the obtained coating film was heated with hot air at 80° C. for 2 minutes for drying of the solvent and alignment aging of the disk-like liquid crystal compound. Subsequently, the obtained coating film was irradiated with UV (500 mJ/cm²) at 80° C. to immobilize the alignment of the liquid crystal compound to form an optically anisotropic layer (1c).

A thickness of the optically anisotropic layer (1c) was 1.1 In addition, an in-plane retardation of the optically anisotropic layer (1c) at a wavelength of 550 nm was 168 nm. It was confirmed that an average tilt angle of a disc plane of the disk-like liquid crystal compound with respect to the film surface was 90°, and the disk-like liquid crystal compound was aligned perpendicular to the film surface. In addition, in a case of viewing from the optically anisotropic layer (1c) side, assuming that a width direction of the film is defined as 0° (a longitudinal direction is defined as 90°), an in-plane slow axis direction of the optically anisotropic layer (1c) was 14°.

In this way, a laminate (1a-1b-1c) in which the optically anisotropic layer (1a), the optically anisotropic layer (1b), and the optically anisotropic layer (1c) were directly laminated on the long cellulose acylate film was produced, thereby obtaining an optical film (1a-1b-1c).

Composition (1c) for forming optically anisotropic layer

| | | |
|---|---|---|
| Disk-like liquid crystal compound 1 shown below | 80 | parts by mass |
| Disk-like liquid crystal compound 2 shown below | 20 | parts by mass |
| Alignment film interface alignment agent 1 shown | 0.55 | parts by mass |
| below | | |
| Fluorine-containing compound A shown below | 0.1 | parts by mass |
| Fluorine-containing compound B shown below | 0.05 | parts by mass |
| Fluorine-containing compound C shown below | 0.21 | parts by mass |
| Ethylene oxide-modified trimethylolpropane | 10 | parts by mass |
| triacrylate (V # 360, manufactured by Osaka | | |
| Organic Chemical Industry Ltd.) | | |
| Photopolymerization initiator (Irgacure 907, | 3.0 | parts by mass |
| manufactured by BASF SE) | | |
| Methyl ethyl ketone | 200 | parts by mass |

Disk-Like Liquid Crystal Compound 1

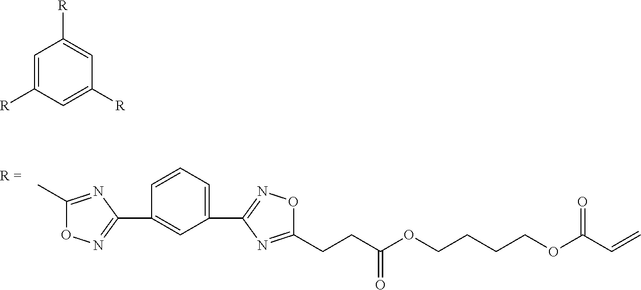

Disk-Like Liquid Crystal Compound 2

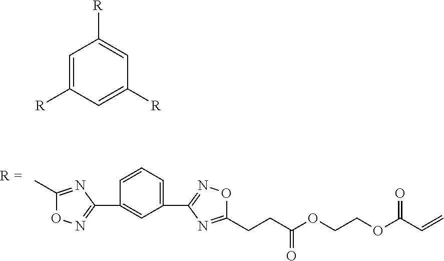

Alignment Film Interface Alignment Agent 1

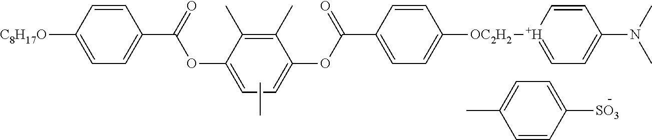

Fluorine-containing compound A (in the following formula, a and b represents a content (% by mass) of each repeating unit with respect to all repeating units, and a was 90% by mass and b was 10% by mass; in addition, a weight-average molecular weight was 15,000)

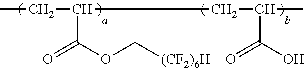

Fluorine-containing compound B (numerical value in each repeating unit represents a content (% by mass) with respect to all repeating units; in addition, a weight-average molecular weight was 12,500)

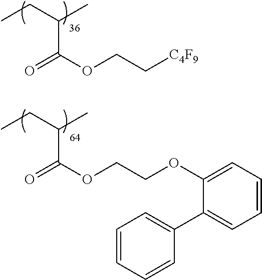

Fluorine-containing compound C (numerical value in each repeating unit represents a content (% by mass) with respect to all repeating units; in addition, a weight-average molecular weight was 12,500)

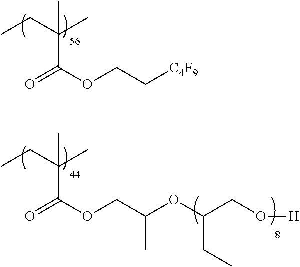

Production of Circularly Polarizing Plate

The surface of the optically anisotropic layer (1c) of the long optical film (1a-1b-1c) produced above and the surface of the polarizer (the surface opposite to the polarizer protective film) of the long linearly polarizing plate produced above were continuously bonded to each other using an ultraviolet curable adhesive.

Next, the cellulose acylate film on the optically anisotropic layer (1a) side was peeled off to expose the surface of the optically anisotropic layer (1a) in contact with the cellulose acylate film. In this way, a circularly polarizing plate (P1) consisting of the phase difference plate (1a-1b-1c) and the linearly polarizing plate was produced. In this case, the polarizer protective film, the polarizer, the optically anisotropic layer (1c), the optically anisotropic layer (1b), and the optically anisotropic layer (1a) were laminated in this order, and an angle formed by the absorption axis of the polarizer and the in-plane slow axis of the optically anisotropic layer (1c) was 76°. In addition, the in-plane slow axis direction of the optically anisotropic layer (1b) on the surface on the optically anisotropic layer (1c) side was 14° with the width direction as a reference of 0°. In addition, the in-plane slow axis direction of the optically anisotropic layer (1b) on the surface on the optically anisotropic layer (1a) side was 95° with the width direction as a reference of 0°.

The in-plane slow axis direction of the optically anisotropic layer is expressed as negative in a case where it is clockwise (right-handed turning) and positive in a case where it is counterclockwise (left-handed turning) with the width direction of the circularly polarizing plate as a reference of 0°, upon observing the circularly polarizing plate from the polarizer side.

### Example 2

Alkali Saponification Treatment

After passing the cellulose acylate film produced above through a dielectric heating roll at a temperature of 60° C. to raise the film surface temperature to 40° C., an alkaline solution having the composition shown below was applied onto a band surface of the film using a bar coater at a coating amount of 14 ml/m², followed by heating to 110° C., and transportation under a steam type far-infrared heater manufactured by Noritake Company Limited for 10 seconds. Subsequently, pure water was applied onto the obtained film at 3 ml/m² using the same bar coater. Next, the obtained film was washed with water by a fountain coater and drained by an air knife three times, and then transported to a drying zone at 70° C. for 10 seconds and dried to produce a cellulose acylate film subjected to an alkali saponification treatment.

Alkaline solution

| | |
|---|---|
| Potassium hydroxide | 4.7 parts by mass |
| Water | 15.8 parts by mass |
| Isopropanol | 63.7 parts by mass |
| Surfactant: C₁₄H₂₉O(CH₂CH₂O)₂₀H | 1.0 parts by mass |
| Propylene glycol | 14.8 parts by mass |

Formation of Alignment Film 1

An alignment film coating liquid 1 having the following composition was continuously applied onto the surface of the cellulose acylate film which had been subjected to the alkali saponification treatment with a #14 wire bar. The obtained coating film was dried with hot air at 60° C. for 60 seconds, and further dried with hot air at 100° C. for 120 seconds. In this way, a film provided with an alignment film 1 on the cellulose acylate film was produced.

Alignment film coating liquid 1

| | | |
|---|---|---|
| Polyvinyl alcohol shown below | 10 | parts by mass |
| Water | 371 | parts by mass |
| Methanol | 119 | parts by mass |
| Glutaraldehyde (crosslinking agent) | 0.5 | parts by mass |
| Citric acid ester (manufactured by Sankyo | 0.175 | parts by mass |
| Chemical Co., Ltd.) | | |

Polyvinyl alcohol (numerical value in each repeating unit represents a content (% by mass) with respect to all repeating units)

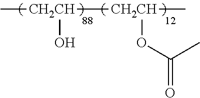

Formation of Optically Anisotropic Layer (2a)

An optically anisotropic layer (2a) was produced in the same manner as in Example 1, except that the film provided with the alignment film 1 on the cellulose acylate film produced above was used instead of the cellulose acylate film, and the following composition (2a) for forming an optically anisotropic layer was used instead of the composition (1a) for forming an optically anisotropic layer.

A film thickness of the optically anisotropic layer (2a) was 0.5 μm. An in-plane retardation of the optically anisotropic layer (2a) at a wavelength of 550 nm was 0 nm, and a thickness direction retardation of the optically anisotropic layer (2a) at a wavelength of 550 nm was −68 nm. It was confirmed that an average tilt angle of a major axis direction of the rod-like liquid crystal compound with respect to the film surface was 90° and the rod-like liquid crystal compound was aligned perpendicular to the film surface.

Composition (2a) for forming optically anisotropic layer

| | | |
|---|---|---|
| Rod-like liquid crystal compound (A) shown | 100 | parts by mass |
| above | | |
| Polymerizable monomer (A-400, manufactured by | 4.0 | parts by mass |
| Shin-Nakamura Chemical Co., Ltd.) | | |
| Polymerization initiator S-1 (oxime type) shown | 5.0 | parts by mass |
| above | | |
| Photoacid generator D-1 shown above | 3.0 | parts by mass |
| Vertical alignment agent S01 shown above | 2.0 | parts by mass |
| Photo-alignment polymer A-1 shown above | 2.0 | parts by mass |
| Methyl ethyl ketone | 42.3 | parts by mass |
| Methyl isobutyl ketone | 627.5 | parts by mass |

Thereafter, by the same procedure as in Example 1, a laminate (2a-1b-1c) in which the optically anisotropic layer (2a), the optically anisotropic layer (1b), and the optically anisotropic layer (1c) were directly laminated on the alignment film 1 formed on the long cellulose acylate film was produced, thereby obtaining an optical film (2a-1b-1c).

In addition, a circularly polarizing plate (P2) was produced according to the same procedure as in Example 1, except that the optical film (2a-1b-1c) was used instead of the optical film (1a-1b-1c), and instead of peeling off the cellulose acylate film on the optically anisotropic layer (1a) side, the cellulose acylate film on which the alignment film 1 was disposed on the optically anisotropic layer (2a) side was peeled off.

### Example 3

A composition (2b) for forming an optically anisotropic layer, containing a rod-like liquid crystal compound and having the following composition, was applied onto the optically anisotropic layer (1a) produced in Example 1 using a Geeser coating machine, and the coating film was heated with hot air at 80° C. for 60 seconds. Subsequently, the obtained coating film was irradiated with UV (500 mJ/cm²) at 80° C. to immobilize the alignment of the liquid crystal compound to form an optically anisotropic layer (2b).

In the optically anisotropic layer (2b), a thickness was 1.2 μm, And at a wavelength of 550 nm was 164 nm, and a twisted angle of the liquid crystal compound was 81°. In a case of viewing from the optically anisotropic layer (2b) side, assuming that a width direction of the film is defined as 0° (a longitudinal direction is defined as 90°), an in-plane slow axis direction of the optically anisotropic layer (2b) on a surface on the air side was 14°, and an in-plane slow axis direction of the optically anisotropic layer (2b) on a surface in contact with an optically anisotropic layer (1a) was 95°.

The above-described in-plane slow axis direction is expressed as negative in a case where it is clockwise (right-handed turning) and positive in a case where it is counterclockwise (left-handed turning) with the width direction of the substrate as a reference of 0°, upon observing the substrate from the surface side of the optically anisotropic layer.

In addition, the twisted angle of the liquid crystal compound is expressed as negative in a case where the in-plane slow axis direction on the substrate side (back side) is clockwise (right-handed turning) and positive in a case where it is counterclockwise (left-handed turning) with reference to the in-plane slow axis direction on the surface side (front side), upon observing the substrate from the surface side of the optically anisotropic layer.

Composition (2b) for forming optically anisotropic layer

| | | |
|---|---|---|
| Rod-like liquid crystal compound (A) shown | 100 | parts by mass |
| above | | |
| Ethylene oxide-modified trimethylolpropane | 4 | parts by mass |
| triacrylate (V # 360, manufactured by Osaka | | |
| Organic Chemical Industry Ltd.) | | |
| Photopolymerization initiator (Irgacure 819, | 3 | parts by mass |
| manufactured by BASF SE) | | |
| Left-handed twisting chiral agent (L1) shown | 0.60 | parts by mass |
| below | | |
| Fluorine-containing compound C shown above | 0.08 | parts by mass |
| Methyl ethyl ketone | 156 | parts by mass |

In this way, a laminate (1a-2b) in which the optically anisotropic layer (1a) and the optically anisotropic layer (2b) were directly laminated on a long cellulose acylate film was produced.

A surface of the optically anisotropic layer (2b) in the laminate (1a-2b) in which the optically anisotropic layer (1a) and the optically anisotropic layer (2b) were directly laminated on the long cellulose acylate film, which was produced by the above-described procedure, was treated once with a corona treatment apparatus under conditions of an output of 0.3 kW and a treatment speed of 7.6 m/min, and then the composition (1c) for forming an optically anisotropic layer was applied thereto using a Geeser coating machine to form a coating film. Next, the obtained coating film was heated with hot air at 80° C. for 2 minutes for drying of the solvent and alignment aging of the disk-like liquid crystal compound. Subsequently, the obtained coating film was irradiated with UV (500 mJ/cm²) at 80° C. to immobilize the alignment of the liquid crystal compound to form an optically anisotropic layer (1c).

A thickness of the optically anisotropic layer (1c) was 1.1 In addition, an in-plane retardation of the optically anisotropic layer (1c) at a wavelength of 550 nm was 168 nm. It was confirmed that an average tilt angle of a disc plane of the disk-like liquid crystal compound with respect to the film surface was 90°, and the disk-like liquid crystal compound was aligned perpendicular to the film surface. In addition, in a case of viewing from the optically anisotropic layer (1c) side, the slow axis was 14°, and the in-plane slow axis direction of the optically anisotropic layer (1c) coincided with the in-plane slow axis direction of the optically anisotropic layer (1b) on the surface on the optically anisotropic layer (1a) side.

In this way, a laminate (1a-2b-1c) in which the optically anisotropic layer (1a), the optically anisotropic layer (2b), and the optically anisotropic layer (1c) were directly laminated on the long cellulose acylate film was produced, thereby obtaining an optical film (1a-2b-1c).

In addition, a circularly polarizing plate (P3) was produced according to the same procedure as in Example 1, except that the optical film (1a-2b-1c) was used instead of the optical film (1a-1b-1c).

### Example 4

An optically anisotropic layer (2a) was produced according to the same procedure as in Example 2.

Thereafter, by the same procedure as in Example 3, a laminate (2a-2b-1c) in which the optically anisotropic layer (2a), the optically anisotropic layer (2b), and the optically anisotropic layer (1c) were directly laminated on the alignment film 1 formed on the long cellulose acylate film was produced, thereby obtaining an optical film (2a-2b-1c).

In addition, a circularly polarizing plate (P4) was produced according to the same procedure as in Example 1, except that the optical film (2a-2b-1c) was used instead of the optical film (1a-1b-1c), and instead of peeling off the cellulose acylate film, the cellulose acylate film on which the alignment film 1 was disposed was peeled off.

### Example 5

A surface of the optically anisotropic layer (1c) of the laminate (1a-2b-1c) in the optical film (1a-2b-1c) produced in Example 3 was treated once with a corona treatment apparatus under conditions of an output of 0.3 kW and a treatment speed of 7.6 m/min, and then a composition (1d) for forming an optically anisotropic layer, containing a disk-like liquid crystal compound and having the following composition, was applied thereto using a Geeser coating machine to form a coating film. Thereafter, both ends of the film were held, a cooling plate (9° C.) was installed on the side of the surface on which the coating film of the film was formed so that the distance from the film was 5 mm, and a heater (110° C.) was installed on the side opposite to the surface on which the coating film of the film was formed so that the distance from the film was 5 mm, followed by drying for 90 seconds.

Next, the obtained film was heated with hot air at 116° C. for 1 minute, and irradiated with ultraviolet rays having an irradiation amount of 150 mJ/cm² using a 365 nm UV-LED while purging with nitrogen so as to have an atmosphere having an oxygen concentration of 100 ppm by mass or less, thereby forming an optically anisotropic layer (1d).

A thickness of the optically anisotropic layer (1d) was 1.0 μm. An in-plane retardation of the optically anisotropic layer (1d) at a wavelength of 550 nm was 0 nm, and a thickness direction retardation of the optically anisotropic layer (1d) at a wavelength of 550 nm was 40 nm. It was confirmed that an average tilt angle of a disc plane of the disk-like liquid crystal compound with respect to the film surface was 0°, and the disk-like liquid crystal compound was horizontally aligned with respect to the film surface.

Composition (1d) for forming optically anisotropic layer

| | | |
|---|---|---|
| Disk-like liquid crystal compound 1 shown above | 8 | parts by mass |
| Disk-like liquid crystal compound 2 shown above | 2 | parts by mass |
| Disk-like liquid crystal compound 3 shown below | 90.0 | parts by mass |
| Polymerizable monomer 1 shown below | 12.0 | parts by mass |
| Polymerization initiator S-1 (oxime type) shown | 3.0 | parts by mass |
| above | | |
| Fluorine-containing compound B shown above | 0.1 | parts by mass |
| Triisopropylamine | 0.2 | parts by mass |
| o-xylene | 634 | parts by mass |

Disk-Like Liquid Crystal Compound 3

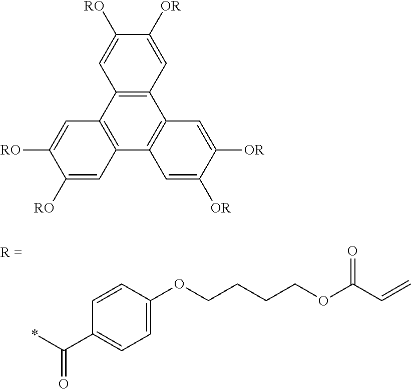

Polymerizable Monomer 1

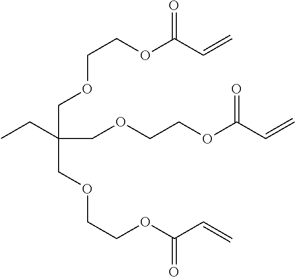 [SMILES: C=CC(=O)OCCOCC(CC)(COCCOC(=O)C=C)COCCOC(=O)C=C]

As described above, a laminate (1a-2b-1c-1d) in which the optically anisotropic layer (1a), the optically anisotropic layer (2b), the optically anisotropic layer (1c), and the optically anisotropic layer (1d) were directly laminated on the long cellulose acylate film was produced, thereby obtaining an optical film (1a-2b-1c-1d).

In addition, a circularly polarizing plate (P5) was produced according to the same procedure as in Example 1, except that the optical film (1a-2b-1c-1d) was used instead of the optical film (1a-1b-1c).

### Example 6

Formation of Optically Anisotropic Layer (2c)

The cellulose acylate film subjected to the alkali saponification treatment, produced in Example 2, was continuously subjected to a rubbing treatment. In this case, the longitudinal direction and the transport direction of the long film were parallel to each other, and an angle between the longitudinal direction (transport direction) of the film and the rotation axis of the rubbing roller was 76°. In a case where the longitudinal direction (transport direction) of the film was defined as 90° and the clockwise direction was represented by a positive value with reference to a width direction of the film as a reference (0°) in a case of being observed from the film side, the rotation axis of the rubbing roller was −14°. In other words, the position of the rotation axis of the rubbing roller is a position rotated by 76° clockwise with reference to the longitudinal direction of the film.

A composition (2c) for forming an optically anisotropic layer, containing a disk-like liquid crystal compound and having the following composition, was applied onto the cellulose acylate film subjected to the rubbing treatment using a Geeser coating machine to form a coating film. Next, the obtained coating film was heated with hot air at 80° C. for 60 seconds for drying of the solvent and alignment aging of the disk-like liquid crystal compound. Next, the obtained coating film was irradiated with ultraviolet rays having an irradiation amount of 100 mJ/cm² at 80° C. using a 365 nm UV-LED while purging with nitrogen so as to have an atmosphere having an oxygen concentration of 100 ppm or less. Thereafter, the obtained film was annealed with hot air at 120° C. for 1 minute to form an optically anisotropic layer (2c).

The obtained optically anisotropic layer (2c) was irradiated with UV light (ultra-high pressure mercury lamp; UL750, manufactured by HOYA Corporation) passing through a wire grid polarizer at room temperature at 7.9 mJ/cm² (wavelength: 313 nm) to impart alignment control ability to the surface.

A thickness of the optically anisotropic layer (2c) was 1.1 In addition, an in-plane retardation of the optically anisotropic layer (2c) at a 550 nm was 168 nm. It was confirmed that an average tilt angle of a disc plane of the disk-like liquid crystal compound with respect to the film surface was 90°, and the disk-like liquid crystal compound was aligned perpendicular to the film surface. In addition, in a case of viewing from the optically anisotropic layer (2c) side, assuming that the in-plane slow axis direction of the optically anisotropic layer (2c) was parallel to the rotation axis of the rubbing roller, and the width direction of the film was 0° (the counterclockwise direction was 90° and the clockwise direction was −90° in the longitudinal direction), the in-plane slow axis direction was −14°.

Composition (2c) for forming optically anisotropic layer

| | | |
|---|---|---|
| Disk-like liquid crystal compound 1 shown above | 80 | parts by mass |
| Disk-like liquid crystal compound 2 shown above | 20 | parts by mass |
| Alignment film interface alignment agent 1 shown | 0.55 | parts by mass |
| above | | |
| Photoacid generator D-1 shown above | 3.0 | parts by mass |
| Photo-alignment polymer A-1 shown above | 2.0 | parts by mass |
| Fluorine-containing compound A shown above | 0.1 | parts by mass |
| Fluorine-containing compound B shown above | 0.05 | parts by mass |
| Ethylene oxide-modified trimethylolpropane | 10 | parts by mass |
| triacrylate (V # 360, manufactured by Osaka | | |
| Organic Chemical Industry Ltd.) | | |
| Photopolymerization initiator (Irgacure 907, | 3.0 | parts by mass |
| manufactured by BASF SE) | | |
| Methyl ethyl ketone | 200 | parts by mass |

A laminate (2c-2b) was produced by providing the optically anisotropic layer (2b) on the optically anisotropic layer (2c) produced as described above in the same procedure as in Example 3.

A surface of the optically anisotropic layer (2b) in the above-described laminate (2c-2b) was treated once with a corona treatment apparatus under conditions of an output of 0.3 kW and a treatment speed of 7.6 m/min, and then a composition (3a) for forming an optically anisotropic layer was applied thereto using a Geeser coating machine to form a coating film. Next, the obtained coating film was heated with hot air at 80° C. for 2 minutes for drying of the solvent and alignment aging of the disk-like liquid crystal compound. Subsequently, the obtained coating film was irradiated with UV (500 mJ/cm²) at 80° C. to immobilize the alignment of the liquid crystal compound to form an optically anisotropic layer (3a).

A thickness of the optically anisotropic layer (3a) was 0.5 μm. An in-plane retardation of the optically anisotropic layer (3a) at a wavelength of 550 nm was 0 nm, and a thickness direction retardation of the optically anisotropic layer (3a) at a wavelength of 550 nm was −68 nm. It was confirmed that an average tilt angle of a major axis direction of the rod-like liquid crystal compound with respect to the film surface was 90° and the rod-like liquid crystal compound was aligned perpendicular to the film surface.

Composition (3a) for forming optically anisotropic layer

| | | |
|---|---|---|
| Rod-like liquid crystal compound (A) shown | 100 | parts by mass |
| above | | |
| Polymerizable monomer (A-400, manufactured by | 4.0 | parts by mass |
| Shin-Nakamura Chemical Co., Ltd.) | | |
| Polymerization initiator S-1 (oxime type) shown | 5.0 | parts by mass |
| above | | |
| Vertical alignment agent S01 shown above | 2.0 | parts by mass |
| Fluorine-containing compound A shown above | 0.1 | parts by mass |
| Fluorine-containing compound C shown above | 0.21 | parts by mass |
| Methyl ethyl ketone | 42.3 | parts by mass |
| Methyl isobutyl ketone | 627.5 | parts by mass |

In this way, a laminate (2c-2b-3a) in which the optically anisotropic layer (2c), the optically anisotropic layer (2b), and the optically anisotropic layer (3a) were directly laminated on the long cellulose acylate film was produced, thereby obtaining an optical film (2c-2b-3a).

Production of Circularly Polarizing Plate

The surface of the cellulose acylate film of the long optical film (2c-2b-3a) produced above in the optically anisotropic layer (2c) side and the surface of the polarizer (the surface opposite to the polarizer protective film) of the long linearly polarizing plate produced above were continuously bonded to each other using an ultraviolet curable adhesive.

In this way, a circularly polarizing plate (P6) consisting of the optical film (2c-2b-3a) and the linearly polarizing plate was produced. In this case, the polarizer protective film, the polarizer, the cellulose acylate film, the optically anisotropic layer (2c), the optically anisotropic layer (2b), and the optically anisotropic layer (3a) were laminated in this order, and an angle formed by the absorption axis of the polarizer and the in-plane slow axis of the optically anisotropic layer (2c) was 76°. In addition, the in-plane slow axis direction of the optically anisotropic layer (2b) on the surface on the optically anisotropic layer (2c) side was 14° with the width direction as a reference of 0°. In addition, the in-plane slow axis direction of the optically anisotropic layer (2b) on the surface on the optically anisotropic layer (3a) side was 95° with the width direction as a reference of 0°.

The in-plane slow axis direction of the optically anisotropic layer is expressed as negative in a case where it is clockwise (right-handed turning) and positive in a case where it is counterclockwise (left-handed turning) with the width direction of the circularly polarizing plate as a reference of 0°, upon observing the circularly polarizing plate from the polarizer side.

### Example 7

The cellulose acylate film subjected to the alkali saponification treatment, produced in Example 2, was continuously subjected to a rubbing treatment. In this case, the longitudinal direction and the transport direction of the long film were parallel to each other, and an angle between the longitudinal direction (transport direction) of the film and the rotation axis of the rubbing roller was 76°. In a case where the longitudinal direction (transport direction) of the film was defined as 90° and the clockwise direction was represented by a positive value with reference to a width direction of the film as a reference (0°) in a case of being observed from the film side, the rotation axis of the rubbing roller was −14°. In other words, the position of the rotation axis of the rubbing roller is a position rotated by 76° clockwise with reference to the longitudinal direction of the film.

The composition (1c) for forming an optically anisotropic layer was applied onto the cellulose acylate film subjected to the rubbing treatment using a Geeser coating machine to form a coating film. Next, the obtained coating film was heated with hot air at 80° C. for 2 minutes for drying of the solvent and alignment aging of the disk-like liquid crystal compound. Subsequently, the obtained coating film was irradiated with UV (500 mJ/cm²) at 80° C. to immobilize the alignment of the liquid crystal compound to form an optically anisotropic layer (1c).

A thickness of the optically anisotropic layer (1c) was 1.1 In addition, an in-plane retardation of the optically anisotropic layer (1c) at a 550 nm was 168 nm. It was confirmed that an average tilt angle of a disc plane of the disk-like liquid crystal compound with respect to the film surface was 90°, and the disk-like liquid crystal compound was aligned perpendicular to the film surface. In addition, in a case of viewing from the optically anisotropic layer (1c) side, assuming that the in-plane slow axis direction of the optically anisotropic layer (1c) was parallel to the rotation axis of the rubbing roller, and the width direction of the film was 0° (the counterclockwise direction was 90° and the clockwise direction was −90° in the longitudinal direction), the in-plane slow axis direction was −14°.

The optically anisotropic layer (1c) produced above was treated once with a corona treatment apparatus under conditions of an output of 0.3 kW and a treatment speed of 7.6 m/min, and then the composition (2b) for forming an optically anisotropic layer was applied thereto using a Geeser coating machine. Thereafter, the optically anisotropic layer (2b) was produced according to the same procedure as in Example 3.

Next, the optically anisotropic layer (3a) was formed on the optically anisotropic layer (2b) by the same procedure as in Example 6. In this way, a laminate (1c-2b-3a) in which the optically anisotropic layer (1c), the optically anisotropic layer (2b), and the optically anisotropic layer (3a) were directly laminated on the long cellulose acylate film was produced, thereby obtaining an optical film (1c-2b-3a).

Next, a circularly polarizing plate (P7) was produced according to the same procedure as in Example 6, except that the optical film (1c-2b-3a) was used instead of the optical film (2c-2b-3a).

### Example 8

Formation of Alignment Film 2

An alignment film coating liquid 2 having the following composition was continuously applied onto the alkali saponification treated-surface of the cellulose acylate film which had been subjected to the alkali saponification treatment, produced in Example 2, with a #14 wire bar. The obtained coating film was dried with hot air at 60° C. for 60 seconds, and further dried with hot air at 100° C. for 120 seconds. In this way, a film provided with an alignment film 2 on the cellulose acylate film was produced.

Alignment film coating liquid 2

| | |
|---|---|
| Modified polyvinyl alcohol-1 shown below | 10 parts by mass |
| Polymerization initiator X shown below | 0.5 parts by mass |
| Water | 170 parts by mass |
| Methanol | 57 parts by mass |

Modified polyvinyl alcohol-1 (in the formulae, the numerical value described in each repeating unit represents a content (mol %) of each repeating unit with respect to all repeating units)

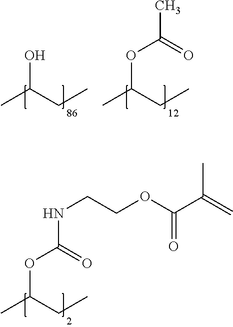

Polymerization Initiator X

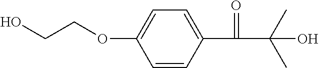 [SMILES: CC(C)(O)C(=O)c1ccc(OCCO)cc1]

A circularly polarizing plate (P8) was produced according to the same procedure as in Example 6, except that the cellulose acylate film having the alignment film 2 produced as described above was used instead of the cellulose acylate film subjected to the alkali saponification treatment, produced in Example 2.

### Example 9

A circularly polarizing plate (P9) was produced according to the same procedure as in Example 7, except that the cellulose acylate film having the alignment film 2 produced in Example 8 was used instead of the cellulose acylate film subjected to the alkali saponification treatment, produced in Example 2.

### Comparative Example 1

Formation of Optically Anisotropic Layer (1e)

The alignment film 2 produced in Example 8 was continuously subjected to a rubbing treatment. In this case, the longitudinal direction and the transport direction of the long film were parallel to each other, and the rubbing direction was adjusted to 13° with respect to the longitudinal direction of the film. An angle of the rubbing direction is represented by a positive angle value in a counterclockwise direction and a negative angle value in a clockwise direction, with the longitudinal direction of the support as a reference of 0°, upon observation of the support from the side on which the optically anisotropic layer was laminated, which will be described later.

Next, a coating liquid (RLC (1)) described in Table 2 of JP5960743B was applied onto the alignment film 2 produced above with a #3 wire bar. A transportation speed (V) of the film was 5 m/min. The coating film was heated with hot air at 110° C. for 2 minutes for drying of the solvent in the coating liquid and alignment aging of the liquid crystal compound. Subsequently, the coating film was irradiated with UV (500 mJ/cm²) at 80° C. in a nitrogen environment to immobilize the alignment of the liquid crystal compound. A thickness of an optically anisotropic layer (1e) was 1.25 μm. In addition, an in-plane retardation of the optically anisotropic layer (1e) at a wavelength of 550 nm was 181 nm.

Formation of Optically Anisotropic Layer (3b)

Without rubbing the optically anisotropic layer (1e) produced above, a coating liquid (RLC (2)) described in Table 2 of JP5960743B was applied onto the optically anisotropic layer (1e) produced above with a #3 wire bar. A transportation speed (V) of the film was 5 m/min.

The coating film was heated with hot air at 110° C. for 2 minutes for drying of the solvent in the coating liquid and alignment aging of the liquid crystal compound. Subsequently, the coating film was irradiated with UV (500 mJ/cm²) at 80° C. in a nitrogen environment to immobilize the alignment of the liquid crystal compound, thereby producing an optically anisotropic layer (3b).

A thickness of an optically anisotropic layer (3b) was 1.19 In addition, And of the optically anisotropic layer (3b) at a wavelength of 550 nm was 172 nm.

An in-plane slow axis of the optically anisotropic layer (3b) on a surface on the optically anisotropic layer (1e) side was parallel to an in-plane slow axis of the optically anisotropic layer (1e). In addition, a twisted angle of the rod-like liquid crystal compound in the optically anisotropic layer (3b) was 81°, and with the longitudinal direction of the support as a reference of 0°, an in-plane slow axis direction of the optically anisotropic layer (3b) on a surface opposite to the optically anisotropic layer (1e) side was 94°. That is, the rod-like liquid crystal compound formed a twisted structure in a clockwise direction.

The above-described in-plane slow axis direction is represented by a positive angle value in a counterclockwise direction and a negative angle value in a clockwise direction, with the longitudinal direction of the support as a reference of 0°, upon observation of the support from the side on which the optically anisotropic layer was laminated.

In addition, in the twisted structure of the rod-like liquid crystal compound here, it is determined whether the in-plane slow axis is clockwise or counterclockwise with the in-plane slow axis of the optically anisotropic layer (3b) on a surface opposite to the optically anisotropic layer (1e) side as a reference, upon observation of the support from the side on which the optically anisotropic layer was laminated.

An optical film (1e-3b) in which the alignment film 2, the optically anisotropic layer (1e), and the optically anisotropic layer (3b) were arranged on the cellulose acylate film was obtained by the above-described procedure.

Next, a circularly polarizing plate (C1) was produced according to the same procedure as in Example 6, except that the optical film (1e-3b) was used instead of the optical film (2c-2b-3a).

### Comparative Example 2

Formation of optically anisotropic layer (3b) The alignment film 1 produced in Example 2 was continuously subjected to a rubbing treatment. In this case, the longitudinal direction and the transport direction of the long film were parallel to each other, and the rubbing direction was adjusted to −94° with respect to the longitudinal direction of the film.

A phase difference plate was produced according to the same procedure as in Comparative Example 1, except that, instead of the coating liquid (RLC (1)) described in Table 2 of JP5960743B, the coating liquid (RLC (2)) described in Table 2 of JP5960743B was applied onto the alignment film 1 subjected to the above-described rubbing treatment, and the coating liquid (RLC (1)) described in Table 2 of JP5960743B was used instead of the coating liquid (RLC (2)) described in Table 2 of JP5960743B.

An optical film (3b-1e) in which the alignment film 1, the optically anisotropic layer (3b), and the optically anisotropic layer (1e) were arranged on the cellulose acylate film was obtained by the above-described procedure.

Next, a circularly polarizing plate (C2) was produced according to the same procedure as in Example 1, except that the optical film (3b-1e) was used instead of the optical film (1a-1b-1c), and instead of peeling off the cellulose acylate film, the cellulose acylate film on which the alignment film 1 was disposed was peeled off.

Evaluation

Mounting on Display Device

The SAMSUNG GALAXY S4 equipped with an organic EL panel was disassembled, a circularly polarizing plate was peeled off, and each of the circularly polarizing plates produced in Examples and Comparative Examples each described above was bonded to the display device using a pressure sensitive adhesive such that the polarizer protective film was arranged on the outside.

Evaluation of Display Performance

The produced organic EL display device was evaluated for tinting of black color. The display device was displayed in black and observed from the front directly under a fluorescent lamp, and tinting and reflected light around the reflected fluorescent lamp were evaluated according to the following standard.

Front Performance
4: tinting was not visible at all (acceptable).
3: although tinting was visible, it was very slight (acceptable).
2: tinting was slightly visible and the reflected light was also slightly present, which are unacceptable.
1: tinting was visible and a lot of reflected light was present, which are unacceptable.

The produced organic EL display device was displayed in black, a fluorescent lamp is projected from a polar angle of 55° under bright light, and tinting and reflected light from all directions were evaluated according to the following standard.

Oblique Performance
4: tinting was not visible at all (acceptable).
3: although tinting was visible, it was very slight (acceptable).
2: tinting was slightly visible and the reflected light was also slightly large, which are unacceptable.
1: tinting was visible and a lot of reflected light was present, which are unacceptable.

In Table 1, the column of “Optical film” indicates the layer configuration of the optical film produced in each of Examples and Comparative Examples.

In Table 1, “First layer” to “Fourth layer” indicate numbers of each optically anisotropic layer. For example, “1a” indicates the optically anisotropic layer (1a).

In Table 1, the column of “Layer configuration” in the column of “Circularly polarizing plate” indicates the lamination order of main members included in the circularly polarizing plate. For example, “Polarizer/1c/1b/1a” of Example 1 indicates that the polarizer, the optically anisotropic layer (1c), the optically anisotropic layer (1b), and the optically anisotropic layer (1a) are laminated in the circularly polarizing plate in this order. “Tack” means the cellulose acylate film.

The refractive index of the optically anisotropic layer produced in each of Examples was more than 1.53.

TABLE 1

| | Optical film | | | | | | Circularly polarizing plate | | Evaluation | |
|---|---|---|---|---|---|---|---|---|---|---|
| | Base | Alignment | | Second | Third | Fourth | | Layer | Front | Oblique |
| | material | film | First layer | layer | layer | layer | Type | configuration | performance | performance |
| Example 1 | Tack | None | 1a | 1b | 1c | — | P1 | Polarizer/1c/1b/1a | 4 | 4 |
| Example 2 | Tack | Alignment | 2a | 1b | 1c | — | P2 | Polarizer/1c/1b/2a | 4 | 4 |
| | | film 1 | | | | | | | | |
| Example 3 | Tack | None | 1a | 2b | 1c | — | P3 | Polarizer/1c/2b/1a | 4 | 4 |
| Example 4 | Tack | Alignment | 2a | 2b | 1c | — | P4 | Polarizer/1c/2b/2a | 4 | 4 |
| | | film 1 | | | | | | | | |
| Example 5 | Tack | None | 1a | 2b | 1c | 1d | P5 | Polarizer/18/1c/2b/1a | 4 | 4 |
| Example 6 | Tack | None | 2c | 2b | 3a | — | P6 | Polarizer/tack/2c/2b/3a | 4 | 4 |
| Example 7 | Tack | None | 1c | 2b | 3a | — | P7 | Polarizer/tack/1c/2b/3a | 4 | 4 |
| Example 8 | Tack | Alignment | 2c | 2b | 3a | — | P8 | Polarizer/tack/alignment film | 3 | 3 |
| | | film 2 | | | | | | 2/2c/2b/3a | | |
| Example 9 | Tack | Alignment | 1c | 2b | 3a | — | P9 | Polarizer/tack/alignment film | 3 | 3 |
| | | film 2 | | | | | | 2/1c/2b/3a | | |
| Comparative | Tack | Alignment | 1e | 3b | — | — | P10 | Polarizer tack positive | 3 | 2 |
| Example 1 | | film 2 | | | | | | A/twisted | | |
| Comparative | Tack | Alignment | 3b | 1e | — | — | P11 | Polarizer/positive A/twisted | 2 | 1 |
| Example 2 | | film 1 | | | | | | | | |

As shown in Table 1, the phase difference plate according to the embodiment of the present invention exhibited a desired effect.

Among these, in comparison between Examples 8 and 9 in which the alignment film 2 was included in the circularly polarizing plate and other Examples, Examples 1 to 7 in which the circularly polarizing plate did not include the alignment film were more effective.

### EXPLANATION OF REFERENCES

10: phase difference plate
12: first optically anisotropic layer
14: second optically anisotropic layer
16: third optically anisotropic layer
20: polarizer
100: circularly polarizing plate

What is claimed is:

1. A phase difference plate comprising:
at least three or more optically anisotropic layers,
wherein the optically anisotropic layers are laminated in a state of being in direct contact with each other,
the phase difference plate includes a first optically anisotropic layer which is a layer formed by fixing a vertically aligned disk-like liquid crystal compound, and
the phase difference plate includes a second optically anisotropic layer which is a layer formed by fixing a rod-like liquid crystal compound twist-aligned along a helical axis extending in a thickness direction.

2. The phase difference plate according to claim 1,
wherein an in-plane retardation of the first optically anisotropic layer at a wavelength of 550 nm is 120 to 240 nm.

3. The phase difference plate according to claim 1,
wherein a product And of a refractive index anisotropy Δn of the second optically anisotropic layer at a wavelength of 550 nm and a thickness d of the second optically anisotropic layer is 120 to 240 nm.

4. The phase difference plate according to claim 1,
wherein the phase difference plate includes a third optically anisotropic layer which is a layer formed by fixing a vertically aligned rod-like liquid crystal compound.

5. The phase difference plate according to claim 4,
wherein a thickness direction retardation of the third optically anisotropic layer at a wavelength of 550 nm is −120 to −10 nm.

6. The phase difference plate according to claim 4,
wherein the phase difference plate includes the first optically anisotropic layer, the second optically anisotropic layer, and the third optically anisotropic layer in this order.

7. The phase difference plate according to claim 1,
wherein a refractive index of the optically anisotropic layer is more than 1.53.

8. A phase difference plate with a temporary support, comprising:
the phase difference plate according to claim 1; and
a temporary support.

9. A circularly polarizing plate comprising:
the phase difference plate according to claim 1; and
a polarizer.

10. The circularly polarizing plate according to claim 9,
wherein a luminosity corrected single transmittance of the polarizer is 42% or more.

11. A display device comprising:
the phase difference plate according to claim 1.
